(19) United States
(12) Patent Application Publication
(10) Pub. No.: US 2014/0137015 A1
(43) Pub. Date: May 15, 2014

(54) Method and Apparatus for Manipulating Digital Content

(71) Applicant: SMART TECHNOLOGIES ULC, Calgary (CA)

(72) Inventor: Patrick Gurtler, Calgary (CA)

(73) Assignee: SMART TECHNOLOGIES ULC, Calgary, AB (CA)

(21) Appl. No.: 13/674,781

(22) Filed: Nov. 12, 2012

(51) Int. Cl. G06F 3/0484

(52) U.S. Cl. CPC G06F 3/0484
USPC 715/765

(57) ABSTRACT

A method comprises detecting when an input device is moved across digital content presented on a display surface and comparing at least one attribute assigned to the input device with at least one attribute assigned to the digital content; and based on the result of the comparison, manipulating the digital content.

### CROSS-REFERENCE TO RELATED APPLICATIONS

This application is related to U.S. patent application Ser. No. 12/709,424 to Bolt et al. filed on Feb. 19, 2010, entitled “INTERACTIVE INPUT SYSTEM AND TOOL TRAY THEREFOR” and U.S. patent application Ser. No. 13/027,717 filed on Feb. 15, 2011, entitled “INTERACTIVE INPUT SYSTEM AND TOOL TRAY THEREFOR”, the entire disclosures of which are incorporated herein by reference.

### FIELD OF THE INVENTION

The present invention relates to a method and apparatus for manipulating digital content.

### BACKGROUND OF THE INVENTION

Interactive input systems that allow users to inject input (e.g. digital ink, mouse events, etc.) into an application program using an active pointer (eg. a pointer that emits light, sound or other signal), a passive pointer (eg. a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; 7,274,356; and 7,532,206 assigned to SMART Technologies ULC of Calgary, Alberta, Canada, assignee of the subject application, the entire disclosures of which are incorporated by reference; touch systems comprising touch panels employing electromagnetic, capacitive, acoustic or other technologies to register pointer input; laptop and tablet personal computers (PCs); smartphones, personal digital assistants (PDAs) and other handheld devices; and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital imaging devices at its corners. The digital imaging devices have overlapping fields of view that encompass and look generally across the touch surface. The digital imaging devices acquire images looking across the touch surface from different vantages and generate image data. Image data acquired by the digital imaging devices is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

U.S. Pat. No. 7,532,206 to Morrison et al. discloses a touch system and method that differentiates between passive pointers used to contact a touch surface so that pointer position data generated in response to a pointer contact with the touch surface can be processed in accordance with the type of pointer used to contact the touch surface. The touch system comprises a touch surface to be contacted by a passive pointer and at least one imaging device having a field of view looking generally across the touch surface. At least one processor communicates with the at least one imaging device and analyzes images acquired by the at least one imaging device to determine the type of pointer used to contact the touch surface and the location on the touch surface where pointer contact is made. The determined type of pointer and the location on the touch surface where the pointer contact is made are used by a computer to control execution of an application program executed by the computer.

In order to determine the type of pointer used to contact the touch surface, a curve of growth method is employed to differentiate between different pointers. During this method, a horizontal intensity profile (HIP) is formed by calculating a sum along each row of pixels in each acquired image thereby to produce a one-dimensional profile having a number of points equal to the row dimension of the acquired image. A curve of growth is then generated from the HIP by forming the cumulative sum from the HIP.

Many models of interactive whiteboards sold by SMART Technologies ULC under the name SMARTBoard™ that employ machine vision technology to register pointer input have a tool tray mounted below the interactive whiteboard surface that comprises receptacles or slots for holding a plurality of pen tools as well as an eraser tool. These tools are passive devices without a power source or electronics. When a tool is removed from its slot in the tool tray, a sensor in the tool tray detects the removal of that tool allowing the interactive whiteboard to determine that the tool has been selected. SMARTBoard™ software in turn processes the next contact with the interactive whiteboard surface as an action from the selected pen tool, whether the contact is from the selected pen tool or from another pointer such as a finger or other object. Similarly, when the eraser tool is removed from its slot, the SMARTBoard™ software processes the next contact with the interactive whiteboard surface as an erasing action, whether the contact is from the eraser tool, or from another pointer such as a finger or other object. Additionally, two buttons are provided on the tool tray. One of the buttons, when pressed, allows the user to execute typical “right click” mouse functions, such as copy, cut, paste, select all, etc. while the other button when pressed causes an onscreen keyboard to be displayed on the interactive whiteboard surface allowing users to enter text, numbers, etc. Although this existing tool tray provides satisfactory functionality, it is desired to improve and expand upon such functionality.

It is therefore an object at least to provide a novel method and apparatus for manipulating digital content.

### SUMMARY OF THE INVENTION

Accordingly, in one aspect there is provided a method comprising detecting when an input device is moved across digital content presented on a display surface and comparing at least one attribute assigned to the input device with at least one attribute assigned to the digital content; and based on the result of the comparison, manipulating the digital content.

In one embodiment, the at least one attribute is assigned to the input device in response to user interaction such as user interaction with a tool tray that is configured to hold the input device or user interaction with a graphical user interface presented on the display surface. In one form, the input device is an erasing tool and the manipulating comprises erasing digital content such as digital ink. The erasing may comprise erasing digital ink that has an assigned at least one attribute that matches the at least one attribute assigned to the digital ink or erasing digital ink that has an assigned at least one attribute that does not match the at least one attribute assigned to the digital ink. The at least one attribute assigned to the erasing tool may be selected from digital ink colour, digital ink shape, digital ink line width, digital ink line type, digital ink format, digital ink location on the display surface and age of the digital ink.

In another embodiment, the input device may be a pen tool and the manipulating comprises performing an action involving the digital content. The performing may be carried out when the pen tool has an assigned at least one attribute that matches the at least one attribute assigned to the digital content or when the pen tool has an assigned at least one attribute that does not match the at least one attribute assigned to the digital content. The performing may be selected from cutting the digital content, copying the digital content, pasting the digital content, moving the digital content, rotating the digital content, highlighting the digital content, converting the digital content to text, reading the digital content audibly and changing at least one of font size, colour and type of the digital content.

In another aspect there is provided a non-transitory computer readable medium embodying computer executable instructions, which when executed, carry out the method of detecting when an input device is moved across digital content presented on a display surface and comparing at least one attribute assigned to the input device with at least one attribute assigned to the digital content; and based on the result of the comparison, manipulating the digital content.

In another aspect there is provided an apparatus comprising memory; and processing structure communicating with said memory and executing instructions stored therein to cause said apparatus at least to detect when an input device is moved across digital content presented on a display surface and compare at least one attribute assigned to the input device with at least one attribute assigned to the digital content; and based on the result of the comparison, manipulate the digital content.

### BRIEF DESCRIPTION OF THE DRAWINGS

Embodiments will now be described more fully with reference to the accompanying drawings in which:

FIG. 1 is a schematic, partial perspective view of an interactive input system;

FIG. 2 is a block diagram of the interactive input system of FIG. 1;

FIG. 3 is a block diagram of an imaging assembly forming part of the interactive input system of FIG. 1;

FIGS. 4a and 4b are front and rear perspective views of a housing assembly forming part of the imaging assembly of FIG. 3;

FIG. 5 is a block diagram of a master controller forming part of the interactive input system of FIG. 1;

FIG. 6 is a perspective view of a tool tray forming part of the interactive input system of FIG. 1;

FIG. 7 is a top plan view of the tool tray of FIG. 6;

FIG. 8 is an exploded perspective view of the tool tray of FIG. 6;

FIG. 9 is a top plan view of circuit card arrays for use with the tool tray of FIG. 6;

FIGS. 10a and 10b are top and bottom perspective views, respectively, of a power button module for use with the tool tray of FIG. 6;

FIG. 11 is a perspective view of a dummy module for use with the tool tray of FIG. 6;

FIG. 12 is a side view of an eraser tool for use with the tool tray of FIG. 6;

FIGS. 13a and 13b are end views of the eraser tool of FIG. 12 in use, showing erasing of large and small areas, respectively;

FIG. 14 is a side view of a prior art eraser tool;

FIGS. 15a and 15b are simplified exemplary image frames captured by the imaging assembly of FIG. 3 including the eraser tools of FIGS. 12 and 14, respectively;

FIGS. 16a to 16d are top plan views of the tool tray of FIG. 6, showing wireless, RS-232, and USB communications modules, and a projector adapter module, respectively, attached thereto;

FIG. 17 is a perspective view of a tool tray accessory module for use with the tool tray of FIG. 6;

FIG. 18 shows a plurality of lines of digital ink displayed on an interactive surface of the interactive input system of FIG. 1 with a portion of one of the lines of digital ink erased;

FIG. 19 is a perspective view of another embodiment of a tool tray for use with the interactive input system of FIG. 1;

FIG. 20 is a top plan view of another embodiment of a tool tray for use with the interactive input system of FIG. 1;

FIG. 21 is a top plan view of yet another embodiment of a tool tray for use with the interactive input system of FIG. 1;

FIGS. 22a to 22c are top plan views of still yet another embodiment of a tool tray for use with the interactive input system of FIG. 1;

FIG. 23 is a side view of another embodiment of an eraser tool;

FIG. 24 is a side view of yet another embodiment of an eraser tool;

FIG. 25 is a schematic, partial perspective view of another embodiment of an interactive input system;

FIG. 26 is a side view of a pen tool for use with the interactive input system of FIG. 25;

FIG. 27 is a flowchart showing a digital ink erasing method; and

FIG. 28 is a flowchart showing a digital ink selection method.

### DETAILED DESCRIPTION OF THE EMBODIMENTS

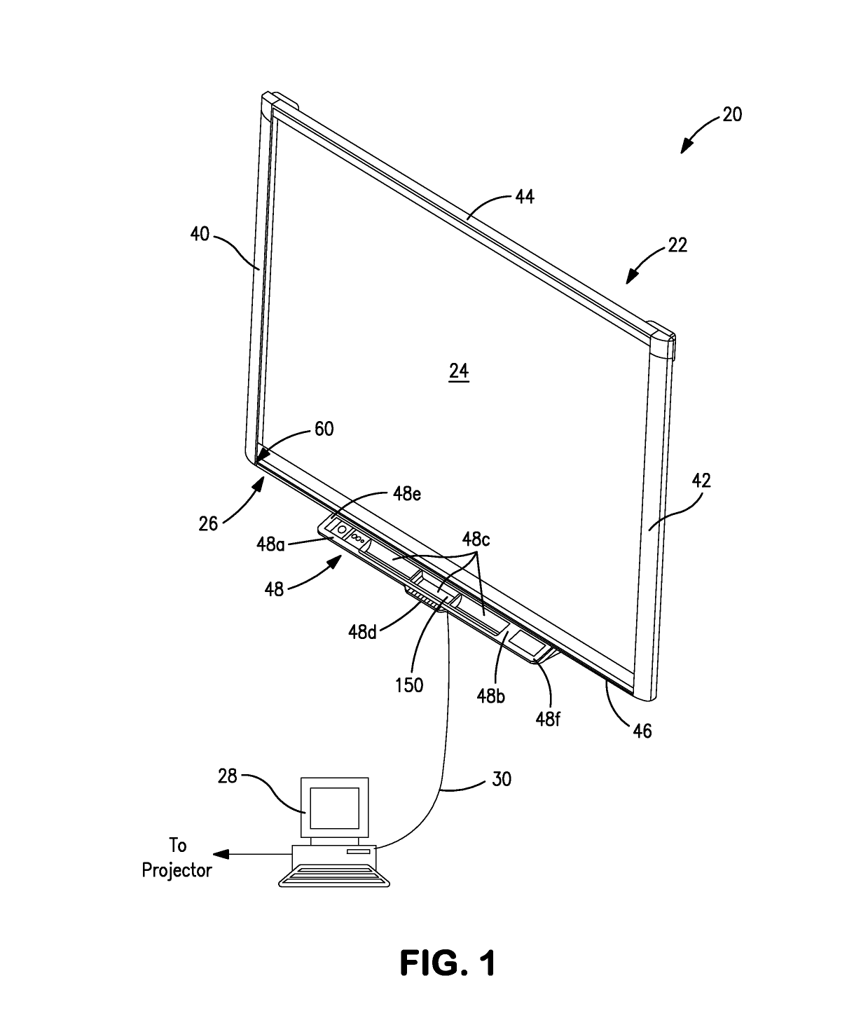

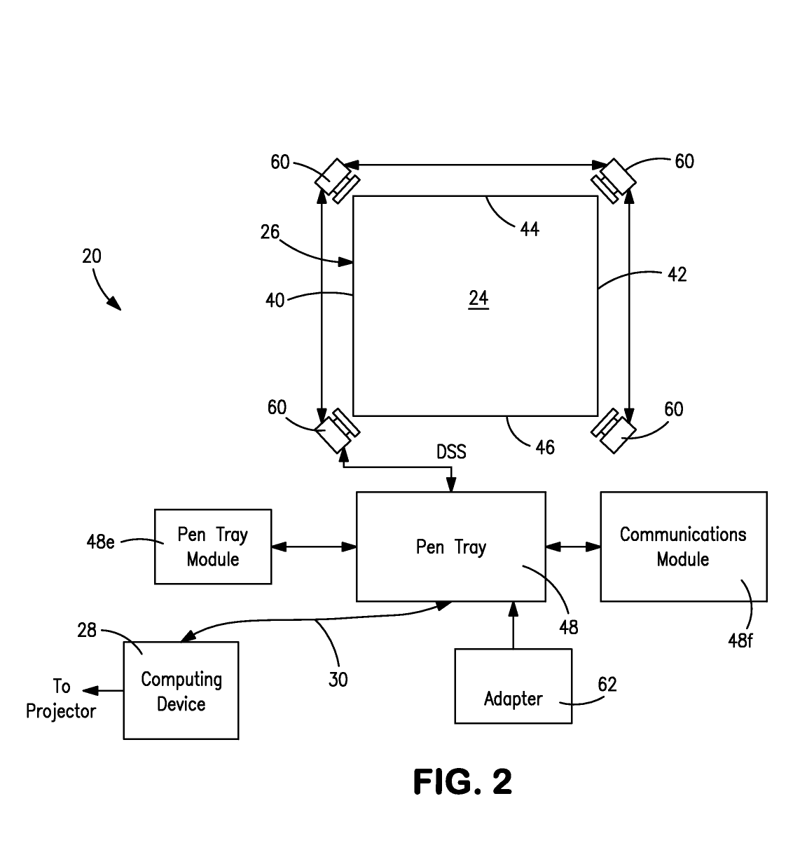

Turning now to FIGS. 1 and 2, an interactive input system that allows a user to inject input such as digital ink, mouse events etc. into an executing application program is shown and is generally identified by reference numeral 20. In this embodiment, interactive input system 20 comprises an interactive board 22 mounted on a vertical support surface such as for example, a wall surface or the like or otherwise supported in a generally upright orientation. Interactive board 22 comprises a generally planar, rectangular interactive surface 24 that is surrounded about its periphery by a bezel 26. An ultra-short throw projector (not shown) such as that sold by SMART Technologies ULC under the name SMART UX60 is also mounted on the support surface above the interactive board 22 and projects an image, such as for example a computer desktop, onto the interactive surface 24.

The interactive board 22 employs machine vision to detect one or more pointers brought into a region of interest in proximity with the interactive surface 24. The interactive board 22 communicates with a general purpose computing device 28 executing one or more application programs via a universal serial bus (USB) cable 30 or other suitable wired or wireless connection. General purpose computing device 28 processes the output of the interactive board 22 and adjusts image data that is output to the projector, if required, so that the image presented on the interactive surface 24 reflects pointer activity. In this manner, the interactive board 22, general purpose computing device 28 and projector allow pointer activity proximate to the interactive surface 24 to be recorded as writing or drawing or used to control execution of one or more application programs executed by the general purpose computing device 28.

The bezel 26 in this embodiment is mechanically fastened or otherwise secured to the interactive surface 24 and comprises four bezel segments 40, 42, 44, 46. Bezel segments 40 and 42 extend along opposite side edges of the interactive surface 24 while bezel segments 44 and 46 extend along the top and bottom edges of the interactive surface 24 respectively. In this embodiment, the inwardly facing surface of each bezel segment 40, 42, 44 and 46 comprises at least one longitudinally extending strip or band of retro-reflective material. To take best advantage of the properties of the retro-reflective material, the bezel segments 40, 42, 44 and 46 are oriented so that their inwardly facing surfaces extend in a plane generally normal to the plane of the interactive surface 24.

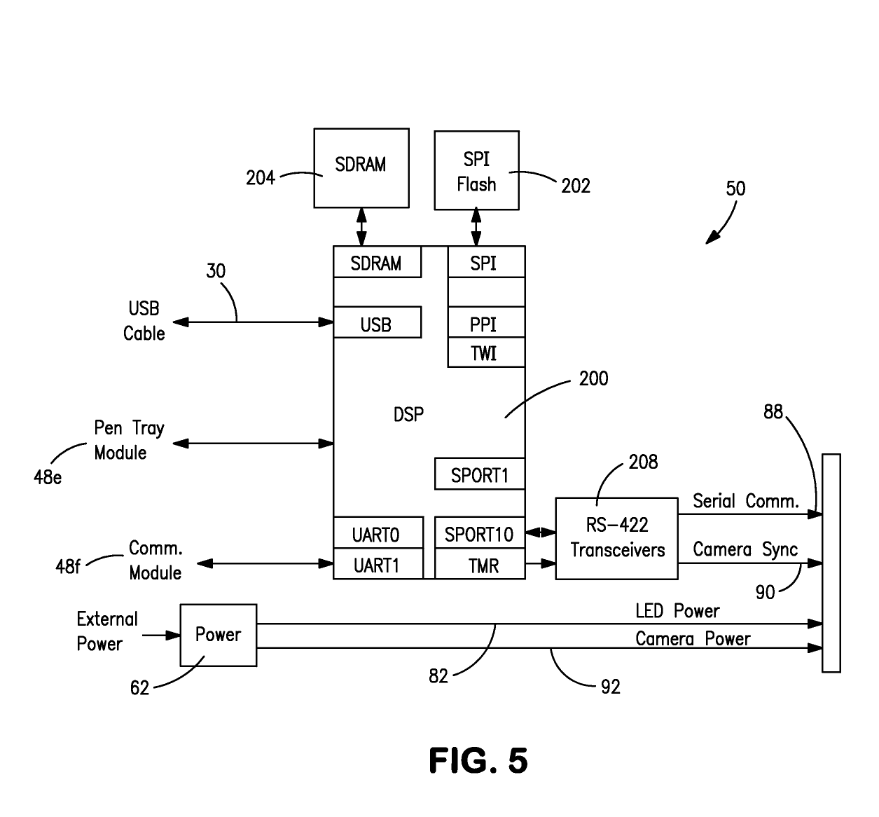

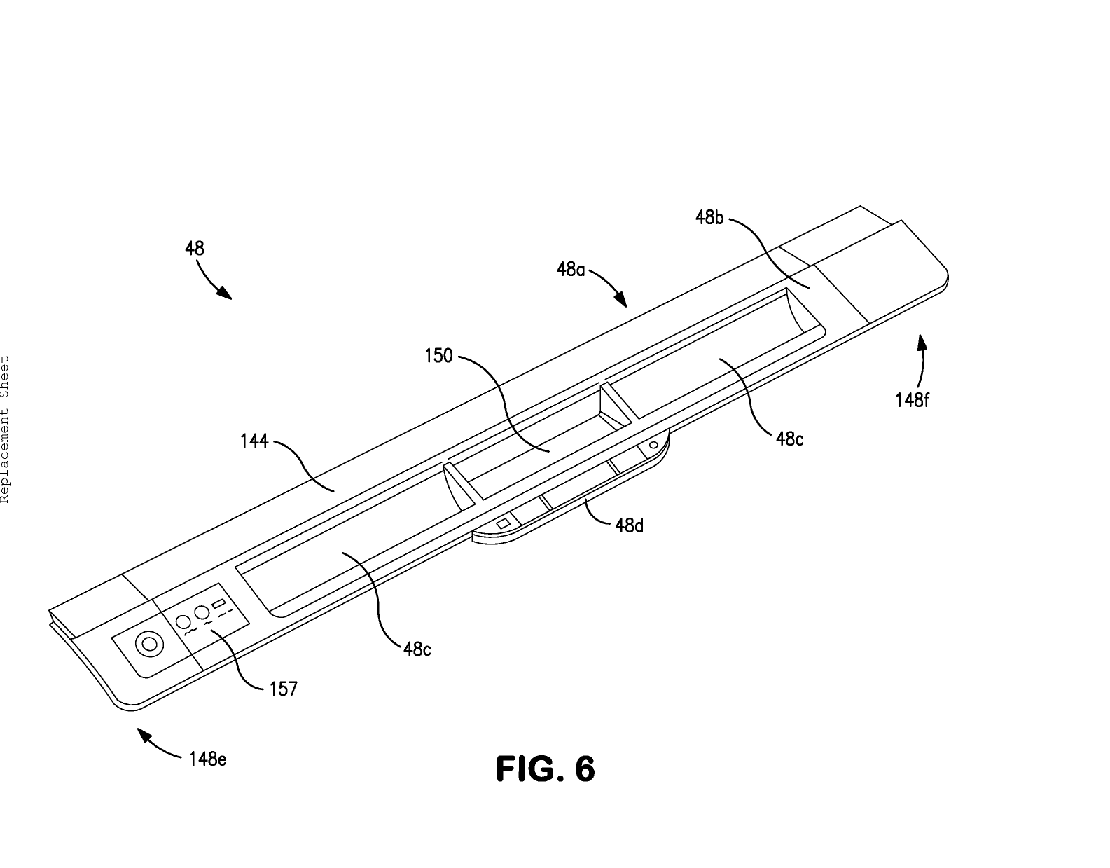

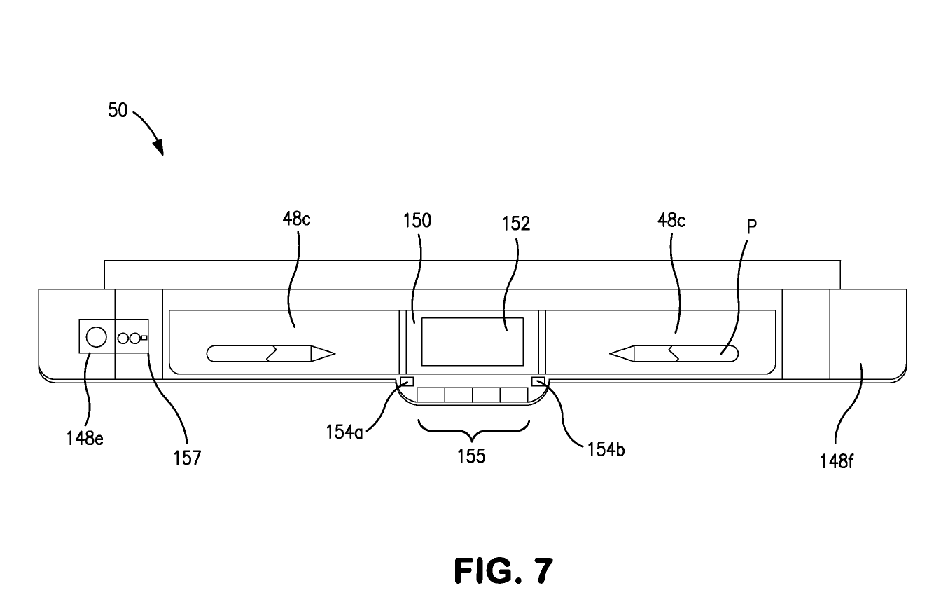

A tool tray 48 of the type described in above-incorporated U.S. patent application Ser. No. 12/709,424 is affixed to the interactive board 22 adjacent the bezel segment 46 using suitable fasteners such as for example, screws, clips, adhesive etc. as best shown in FIG. 6. As can be seen, the tool tray 48 comprises a housing 48a having an upper surface 48b configured to define a plurality of receptacles or slots 48c and 150. The receptacles 48c are sized to receive one or more pen tools P as well as an eraser tool 152 (see FIGS. 7a and 7b) that can be used to interact with the interactive surface 24. A set 48d of buttons is provided on the upper surface 48b of the housing 48a to enable a user to control operation of the interactive input system 20. Opposite ends of the tool tray 48 are configured to detachably receive modules. As shown in FIG. 2, one end of the tool tray 48 receives a detachable tool tray accessory module 48e while the opposite end of the tool tray 48 receives a detachable communications module 48f for remote device communications. The housing 48a accommodates a master controller 50 (see FIG. 5) as will be described.

Looking again at FIG. 2, imaging assemblies 60 are accommodated by the bezel 26, with each imaging assembly 60 being positioned adjacent a different corner of the bezel. The imaging assemblies 60 are oriented so that their fields of view overlap and look generally across the entire interactive surface 24. In this manner, any pointer such as for example a user's finger, a cylinder or other suitable object, or a pen or eraser tool lifted from a receptacle 48c or 150 of the tool tray 48, that is brought into proximity of the interactive surface 24 appears in the fields of view of the imaging assemblies 60. A power adapter 62 provides the necessary operating power to the interactive board 22 when connected to a conventional AC mains power supply.

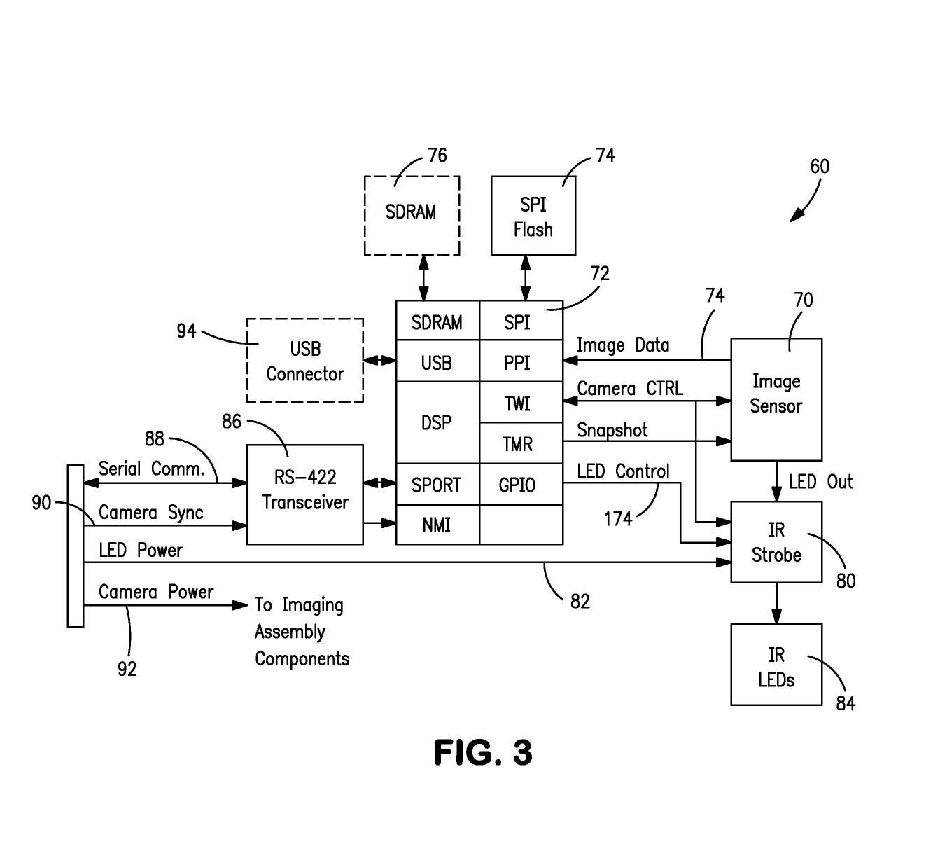

Turning now to FIG. 3, one of the imaging assemblies 60 is better illustrated. As can be seen, the imaging assembly 60 comprises an image sensor 70 such as that manufactured by Aptina (Micron) under Model No. MT9V034 having a resolution of 752×480 pixels, fitted with a two element, plastic lens (not shown) that provides the image sensor 70 with a field of view of approximately 104 degrees. In this manner, the other imaging assemblies 60 are within the field of view of the image sensor 70 thereby to ensure that the field of view of the image sensor 70 encompasses the entire interactive surface 24.

A digital signal processor (DSP) 72 such as that manufactured by Analog Devices under part number ADSP-BF522 Blackfin or other suitable processing device, communicates with the image sensor 70 over an image data bus 74 via a parallel port interface (PPI). A serial peripheral interface (SPI) flash memory 74 is connected to the DSP 72 via an SPI port and stores the firmware required for image assembly operation. Depending on the size of captured image frames as well as the processing requirements of the DSP 72, the imaging assembly 60 may optionally comprise synchronous dynamic random access memory (SDRAM) 76 to store additional temporary data as shown by the dotted lines. The image sensor 70 also communicates with the DSP 72 via a a two-wire interface (TWI) and a timer (TMR) interface. The control registers of the image sensor 70 are written from the DSP 72 via the TWI in order to configure parameters of the image sensor 70 such as the integration period for the image sensor 70.

In this embodiment, the image sensor 70 operates in a snapshot mode. In the snapshot mode, the image sensor 70, in response to an external trigger signal received from the DSP 72 via the TMR interface that has a duration set by a timer on the DSP 72, enters an integration period during which an image frame is captured. Following the integration period after the generation of the trigger signal by the DSP 72 has ended, the image sensor 70 enters a readout period during which time the captured image frame is available. With the image sensor in the readout period, the DSP 72 reads the image frame data acquired by the image sensor 70 over the image data bus 74 via the PPI. The frame rate of the image sensor 70 in this embodiment is between about 900 and about 960 frames per second. The DSP 72 in turn processes image frames received from the image sensor 72 and provides pointer information to the master controller 50 at a reduced rate of approximately 120 points/sec. Those of skill in the art will however appreciate that other frame rates may be employed depending on the desired accuracy of pointer tracking and whether multi-touch and/or active pointer identification is employed.

Strobe circuits 80 communicate with the DSP 72 via the TWI and via a general purpose input/output (GPIO) interface. The IR strobe circuits 80 also communicate with the image sensor 70 and receive power provided on LED power line 82 via the power adapter 52. Each strobe circuit 80 drives a respective illumination source in the form of an infrared (IR) light emitting diode (LED) 84 that provides infrared backlighting over the interactive surface 24. Further specifics concerning the strobe circuits 80 and their operation are described in U.S. Application Publication No. 2011/0169727 to Akitt entitled “INTERACTIVE INPUT SYSTEM AND ILLUMINATION SYSTEM THEREFOR” filed on even Feb. 19, 2010, the disclosure of which is incorporated herein by reference in its entirety.

The DSP 72 also communicates with an RS-422 transceiver 86 via a serial port (SPORT) and a non-maskable interrupt (NMI) port. The transceiver 86 communicates with the master controller 50 over a differential synchronous signal (DSS) communications link 88 and a synch line 90. Power for the components of the imaging assembly 60 is provided on power line 92 by the power adapter 62. DSP 72 may also optionally be connected to a USB connector 94 via a USB port as indicated by the dotted lines. The USB connector 94 can be used to connect the imaging assembly 60 to diagnostic equipment.

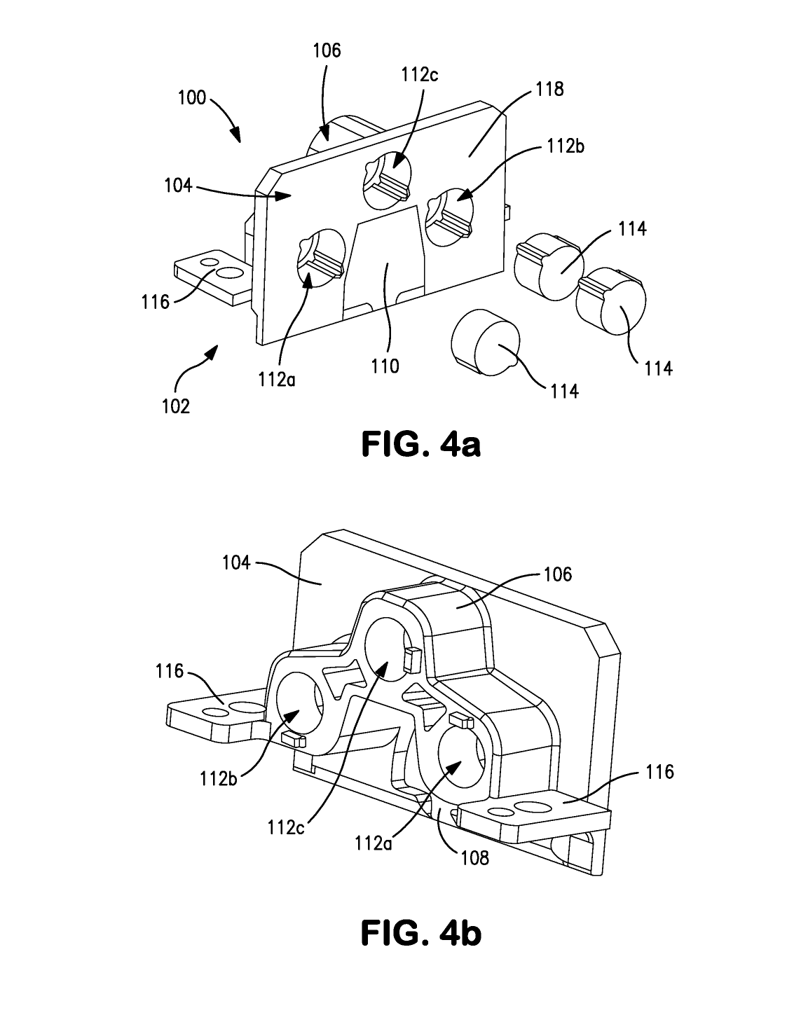

The image sensor 70 and its associated lens as well as the IR LEDs 84 are mounted on a housing assembly 100 that is shown in FIGS. 4a and 4b. As can be seen, the housing assembly 100 comprises a polycarbonate housing body 102 having a front portion 104 and a rear portion 106 extending from the front portion. An imaging aperture 108 is centrally formed in the housing body 102 and accommodates an IR-pass/visible light blocking filter 110. The filter 110 has an IR-pass wavelength range of between about 830 nm and about 880 nm. The image sensor 70 and associated lens are positioned behind the filter 110 and oriented such that the field of view of the image sensor 70 looks through the filter 110 and generally across the interactive surface 24. The rear portion 106 is shaped to surround the image sensor 70. Three passages 112a to 112c are formed through the housing body 102. Passages 112a and 112b are positioned on opposite sides of the filter 110 and are in general horizontal alignment with the image sensor 70. Passage 112c is centrally positioned above the filter 110. Each tubular passage receives a light source socket 114 that is configured to receive a respective one of the IR LEDs 84. Mounting flanges 116 are provided on opposite sides of the rear portion 106 to facilitate connection of the housing assembly 100 to the bezel 26 via suitable fasteners. A label 118 formed of retro-reflective material overlies the front surface of the front portion 104. Further specifics concerning the housing assembly and its method of manufacture are described in U.S. Application Publication No. 2011/0170253 to Liu et al. entitled “HOUSING ASSEMBLY FOR INTERACTIVE INPUT SYSTEM AND FABRICATION METHOD” filed on Feb. 19, 2010, the disclosure of which is incorporated herein by reference in its entirety.

The master controller 50 is better illustrated in FIG. 5. As can be seen, master controller 50 comprises a DSP 200 such as that manufactured by Analog Devices under part number ADSP-BF522 Blackfin or other suitable processing device. A serial peripheral interface (SPI) flash memory 202 is connected to the DSP 200 via an SPI port and stores the firmware required for master controller operation. A synchronous dynamic random access memory (SDRAM) 204 that stores temporary data necessary for system operation is connected to the DSP 200 via an SDRAM port. The DSP 200 communicates with the general purpose computing device 28 over the USB cable 30 via a USB port. The DSP 200 communicates through its serial port (SPORT) with the imaging assemblies 60 via an RS-422 transceiver 208 over the differential synchronous signal (DSS) communications link 88. In this embodiment, as more than one imaging assembly 60 communicates with the master controller DSP 200 over the DSS communications link 88, time division multiplexed (TDM) communications is employed. The DSP 200 also communicates with the imaging assemblies 60 via the RS-422 transceiver 208 over the camera synch line 90. DSP 200 communicates with the tool tray accessory module 48e over an inter-integrated circuit I²C channel and communicates with the communications accessory module 48f over universal asynchronous receiver/transmitter (UART), serial peripheral interface (SPI) and I²C channels.

As will be appreciated, the architectures of the imaging assemblies 60 and master controller 50 are similar. By providing a similar architecture between each imaging assembly 60 and the master controller 50, the same circuit board assembly and common components may be used for both thus reducing the part count and cost of the interactive input system 20. Differing components are added to the circuit board assemblies during manufacture dependent upon whether the circuit board assembly is intended for use in an imaging assembly 60 or in the master controller 50. For example, the master controller 50 may require a SDRAM 76 whereas the imaging assembly 60 may not.

The general purpose computing device 28 in this embodiment is a personal computer or other suitable processing device comprising, for example, a processing unit, system memory (volatile and/or non-volatile memory), other non-removable or removable memory (eg. a hard disk drive, RAM, ROM, EEPROM, CD-ROM, DVD, flash memory, etc.) and a system bus coupling the various computing device components to the processing unit. The general purpose computing device 28 may also comprise a network connection to access shared or remote drives, one or more networked computers, or other networked devices.

During operation, the DSP 200 of the master controller 50 outputs synchronization signals that are applied to the synch line 90 via the transceiver 208. Each synchronization signal applied to the synch line 90 is received by the DSP 72 of each imaging assembly 60 via transceiver 86 and triggers a non-maskable interrupt (NMI) on the DSP 72. In response to the non-maskable interrupt triggered by the synchronization signal, the DSP 72 of each imaging assembly 60 ensures that its local timers are within system tolerances and if not, corrects its local timers to match the master controller 50. Using one local timer, the DSP 72 initiates a pulse sequence via the snapshot line that is used to condition the image sensor to the snapshot mode and to control the integration period and frame rate of the image sensor 70 in the snapshot mode. The DSP 72 also initiates a second local timer that is used to provide output on the LED control line 174 so that the IR LEDs 84 are properly powered during the image frame capture cycle.

In response to the pulse sequence output on the snapshot line, the image sensor 70 of each imaging assembly 60 acquires image frames at the desired image frame rate. In this manner, image frames captured by the image sensor 70 of each imaging assembly can be referenced to the same point of time allowing the position of pointers brought into the fields of view of the image sensors 70 to be accurately triangulated. Each imaging assembly 60 has its own local oscillator (not shown) and synchronization signals are distributed so that a lower frequency synchronization signal (e.g. the point rate, 120 Hz) for each imaging assembly 60 is used to keep image frame capture synchronized. By distributing the synchronization signals for the imaging assemblies 60, rather than transmitting a fast clock signal to each image assembly 60 from a central location, electromagnetic interference is reduced.

During image frame capture, the DSP 72 of each imaging assembly 60 also provides output to the strobe circuits 80 to control the switching of the IR LEDs 84. When each IR LED 84 is on, the IR LED floods the region of interest over the interactive surface 24 with infrared illumination. Infrared illumination that impinges on the retro-reflective bands of bezel segments 40, 42, 44 and 46 and on the retro-reflective labels 118 of the housing assemblies 100 is returned to the imaging assemblies 60. As a result, in the absence of a pointer, the image sensor 70 of each imaging assembly 60 sees a bright band having a substantially even intensity over its length together with any ambient light artifacts. When a pointer is brought into proximity with the interactive surface 24, the pointer occludes infrared illumination reflected by the retro-reflective bands of bezel segments 40, 42, 44 and 46 and/or the retro-reflective labels 118. As a result, the image sensor 70 of each imaging assembly 60 sees a dark region that interrupts the bright band in captured image frames. The reflections of the illuminated retro-reflective bands of bezel segments 40, 42, 44 and 46 and the illuminated retro-reflective labels 118 appearing on the interactive surface 24 are also visible to the image sensor 70.

The sequence of image frames captured by the image sensor 70 of each imaging assembly 60 is processed by the DSP 72 to remove ambient light artifacts, and to identify each pointer in each image frame and generate pointer data. The DSP 72 of each imaging assembly 60 in turn conveys the pointer data to the DSP 200 of the master controller 50. The DSP 200 uses the pointer data received from the DSPs 72 to calculate the position of each pointer relative to the interactive surface 24 in (x,y) coordinates using well known triangulation as described in above-incorporated U.S. Pat. No. 6,803,906 to Morrison. This pointer coordinate data is conveyed to the general purpose computing device 28 allowing the image data presented on the interactive surface 24 to be updated if required.

Turning now to FIGS. 6 to 11, as can be seen and as mentioned previously, opposite ends of the tool tray 48 are configured to receive detachable modules. In these figures, one end of the housing 48a has a power button module 148e attached thereto and the other end of the housing 48a has a dummy module 148f attached thereto. Other modules may alternatively be connected to the housing 48a of the tool tray 48 to provide different functionality, as will be described. Additionally, tool tray 48 has a rear portion 144 defining a generally planar mounting surface that is shaped for abutting against an underside of the interactive board 22, and thereby provides a surface for the tool tray 48 to be mounted to the interactive board. In this embodiment, upper surface 48b defines two receptacles or slots 48c, each configured to support a respective pen tool P, and a receptacle or slot 150 configured to support an eraser tool 152.

The set 48d of buttons is positioned centrally along the front edge of the housing 48a and allows user selection of an attribute of pointer input. In the embodiment shown, there are six attribute buttons 154a, 154b and 155a to 155d. Each of the attribute buttons permits a user to select a different attribute that is to be assigned to pointer input. In this example, the two outermost buttons 154a and 154b are assigned to left mouse-click and right mouse-click functions, respectively, while attribute buttons 155a, 155b, 155c, and 155d are assigned to different colours, in this example black, blue, green and red colours, respectively.

Tool tray 48 is equipped with a main power button 156 which, in this embodiment, is housed within the power button module 148e. Power button 156 controls the on/off status of the interactive input system 20, together with any accessories connected the interactive input system 20, such as, for example, the projector (not shown). As will be appreciated, power button 156 is positioned at an intuitive, easy-to-find location and therefore allows a user to switch the interactive input system 20 on and off in a facile manner. Tool tray 48 also has a set of assistance buttons 157 positioned near one end of the housing 48a for enabling a user to request help from the interactive input system. In this embodiment, assistance buttons 157 comprise an “orient” button 157a and a “help” button 157b.

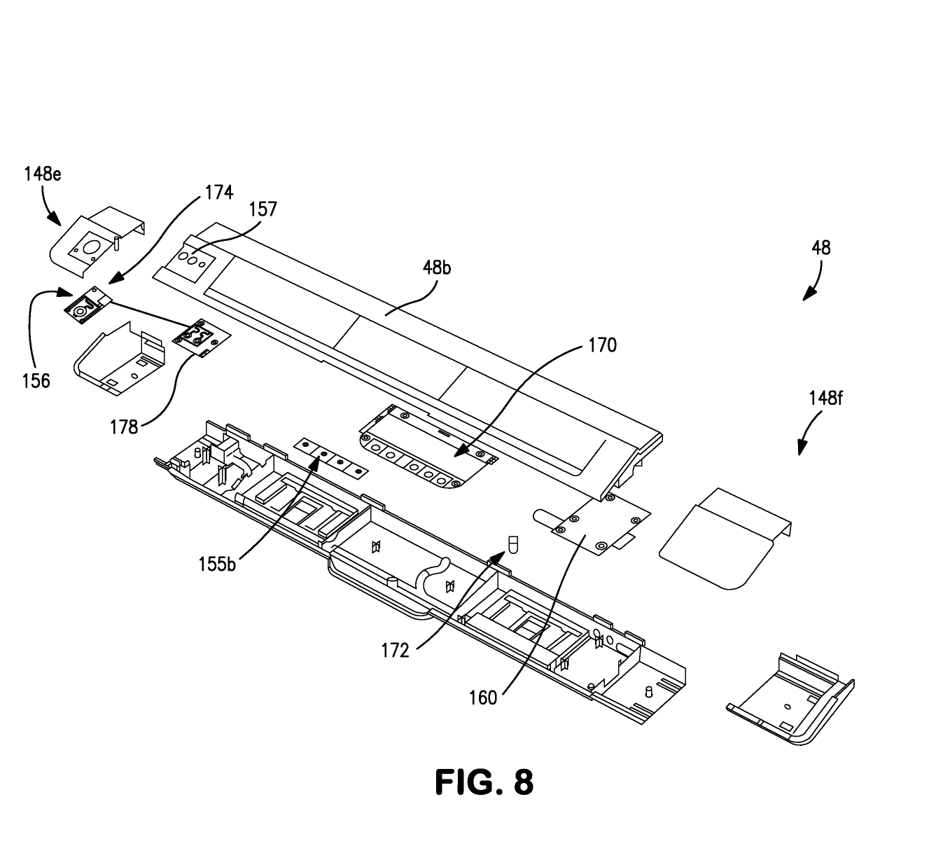

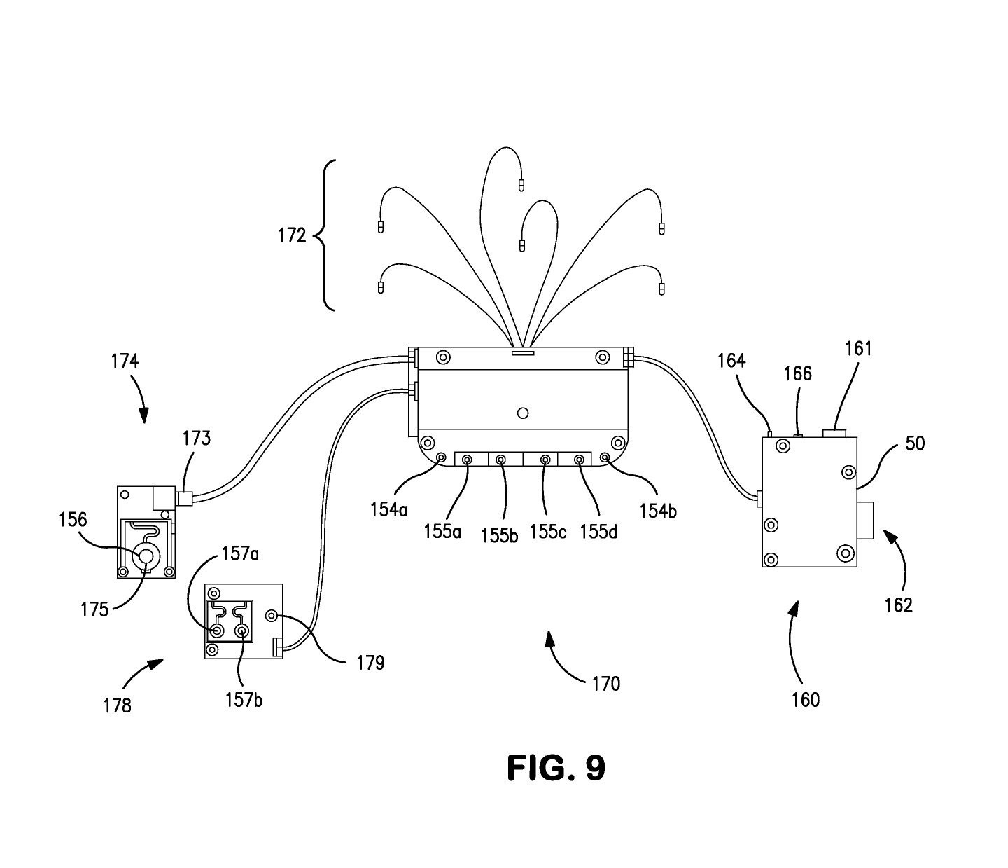

The internal components of tool tray 48 may be more clearly seen in FIGS. 8 and 9. The interior of housing 48a accommodates a plurality of circuit card arrays (CCAs), each supporting circuitry associated with the functionality of the tool tray 48. Main controller board 160 supports the master controller 50, which generally controls the overall functionality of the tool tray 48. Main controller board 160 also comprises USB connector 94 (not shown in FIGS. 8 and 9), and a data connection port 161 for enabling connection to the imaging assemblies 60. Main controller board 160 also has an expansion connector 162 for enabling connection to the communications module 48f when it is installed on the end of the tool tray 48. Main controller board 160 additionally has a power connection port 164 for enabling connection to power adapter 62, and an audio output port 166 for enabling connection to one or more speakers (not shown).

Main controller board 160 is connected to an attribute control board 170, on which attribute buttons 154a, 154b and 155a to 155d are mounted. Attribute control board 170 further comprises a set of visual indicators, in this case four (4) light emitting diodes (LEDs) (not shown). Each LED is housed within a respective attribute button 155a to 155d, and is used to indicate the activity status of its respective attribute button. In this embodiment, the LEDs are of different colors for example white, blue, green and red, respectively. Attribute control board 170 also comprises tool sensors 172. The tool sensors 172 are grouped into three pairs, with each pair being mounted as a set within a respective receptacle 48c or receptacle 150 for detecting the presence of a tool within that receptacle. In this embodiment, each pair of sensors 172 comprises an infrared transmitter and receiver, whereby tool detection occurs by interruption of the infrared signal across the slot in which the pair of sensors 172 is positioned.

Attribute control board 170 is in turn linked to a connector 173 for enabling removable connection to a power module board 174, which is housed within the interior of power button module 148e. Power module board 174 has the power button 156 physically mounted thereon, together with a visual indicator in the form of an LED 175 contained within the power button 156 for indicating power on/off status.

Attribute control board 170 is also connected to an assistance button control board 178, on which “orient” button 157a and “help” button 157b are mounted. A single visual indicator in the form of LED 179 is associated with the buttons 157a and 157b for indicating that one of buttons has been depressed.

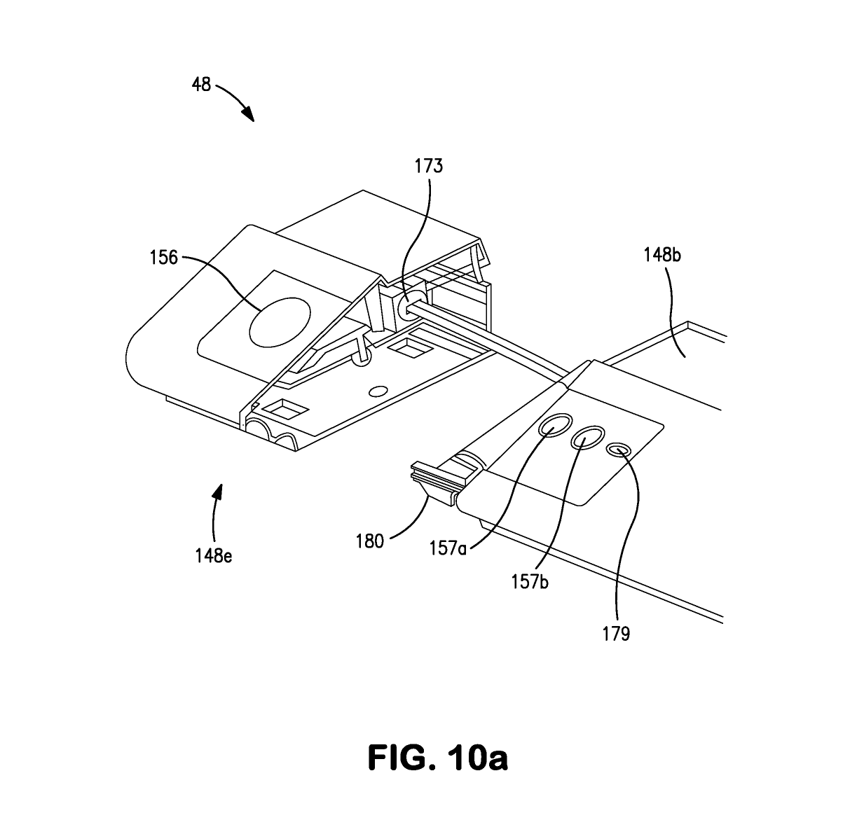

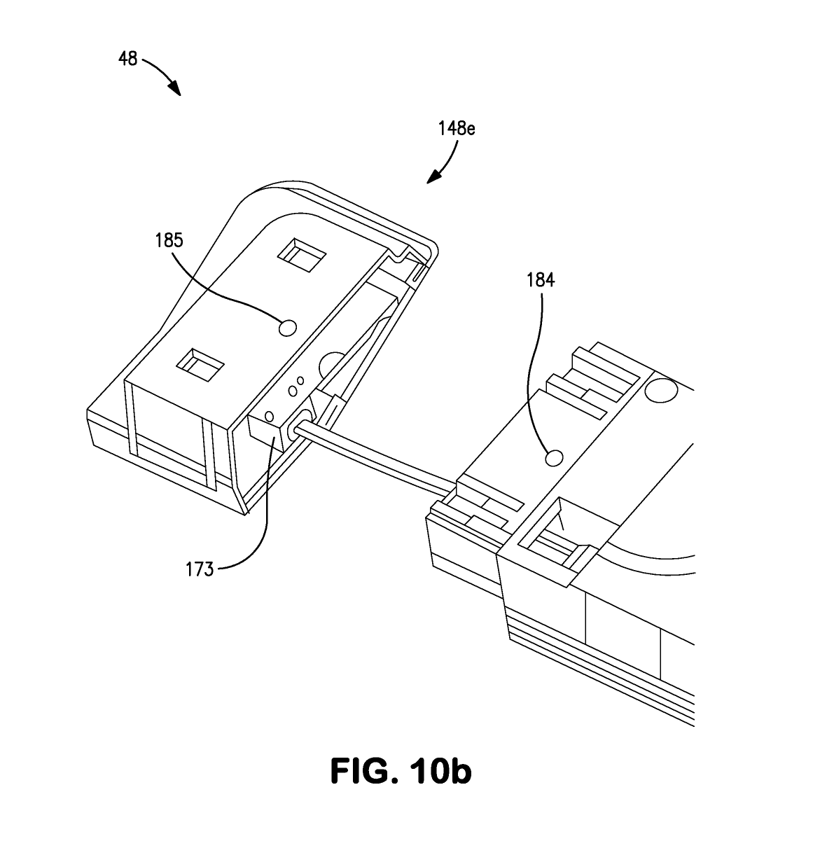

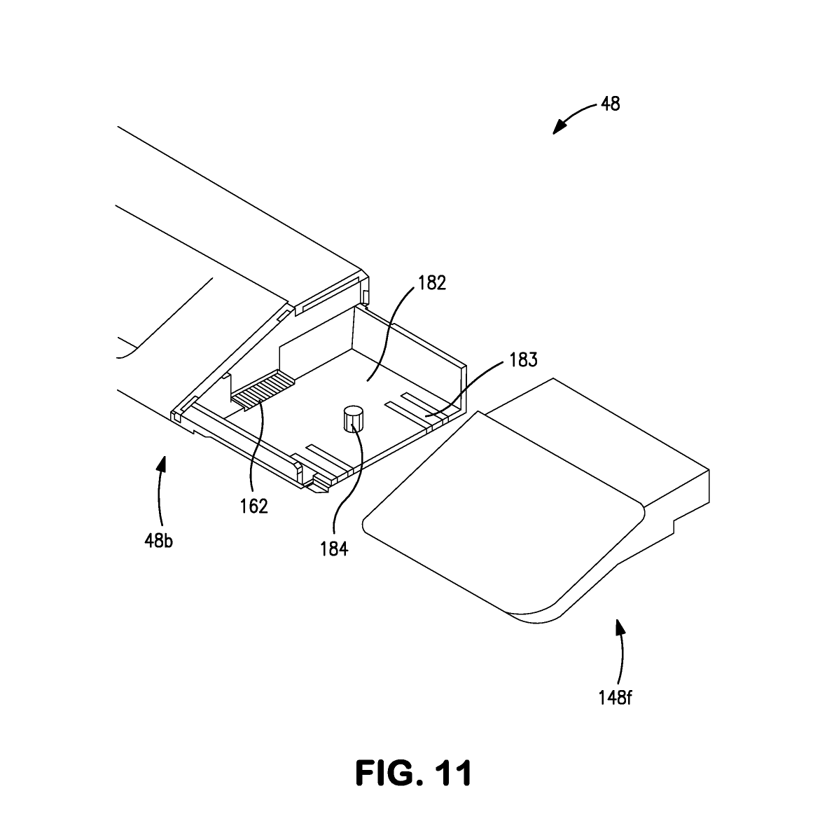

Housing 48a comprises a protrusion 180 at each of its ends to facilitate physical attachment of the modules thereto. For example, FIGS. 10a and 10b and FIG. 11, show opposite ends of the housing 48a with the modules 148e and 148f removed. The protrusion 180 at each end of the housing 48a is shaped to engage the interior of the modules 148e and 148f in an abutting male-female relationship. Each protrusion 180 has two laterally spaced clips 183, each for cooperating with a suitably positioned tab (not shown) within the base of its respective module 148e and 148f. Additionally, each protrusion 180 has a bored post 184 with internal threads thereon positioned to cooperate with a corresponding aperture 185 formed in the base of its respective module 148e and 148f, allowing the modules to be secured to housing 48a by fasteners.

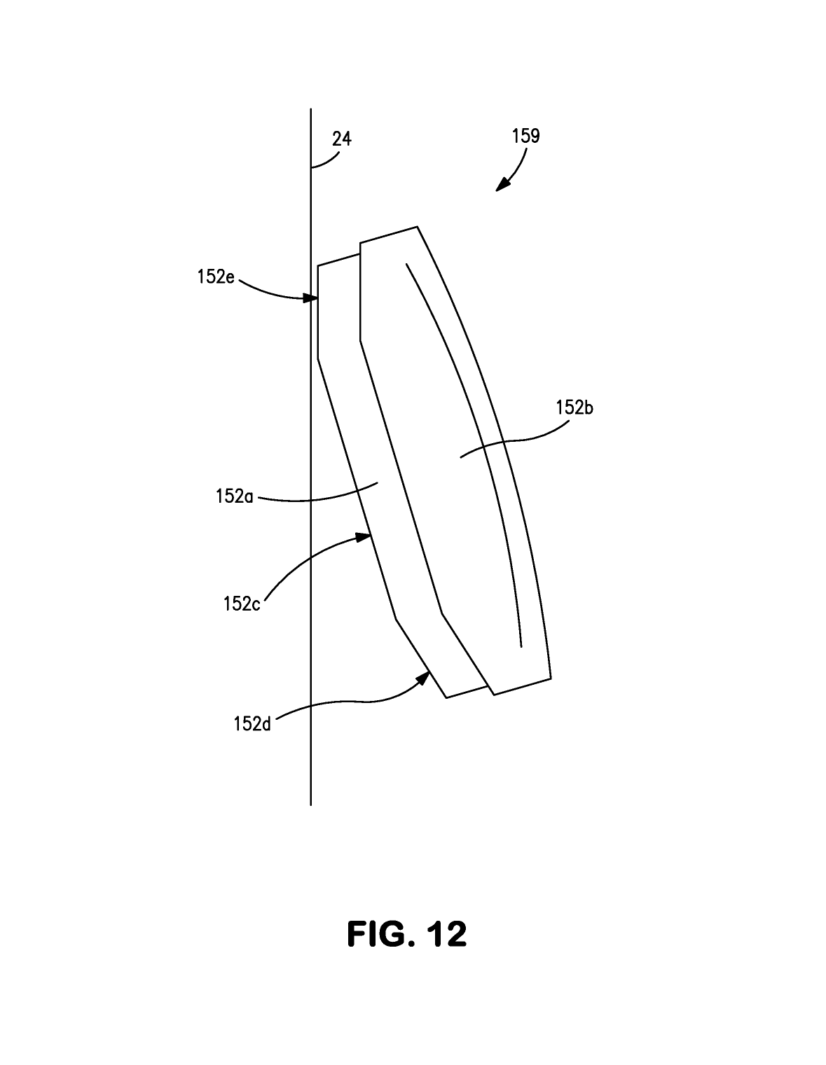

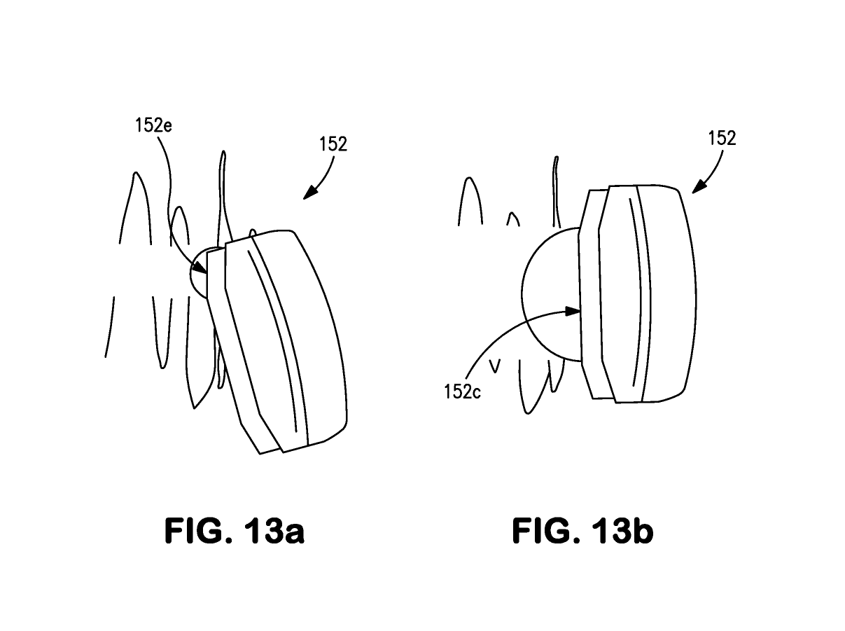

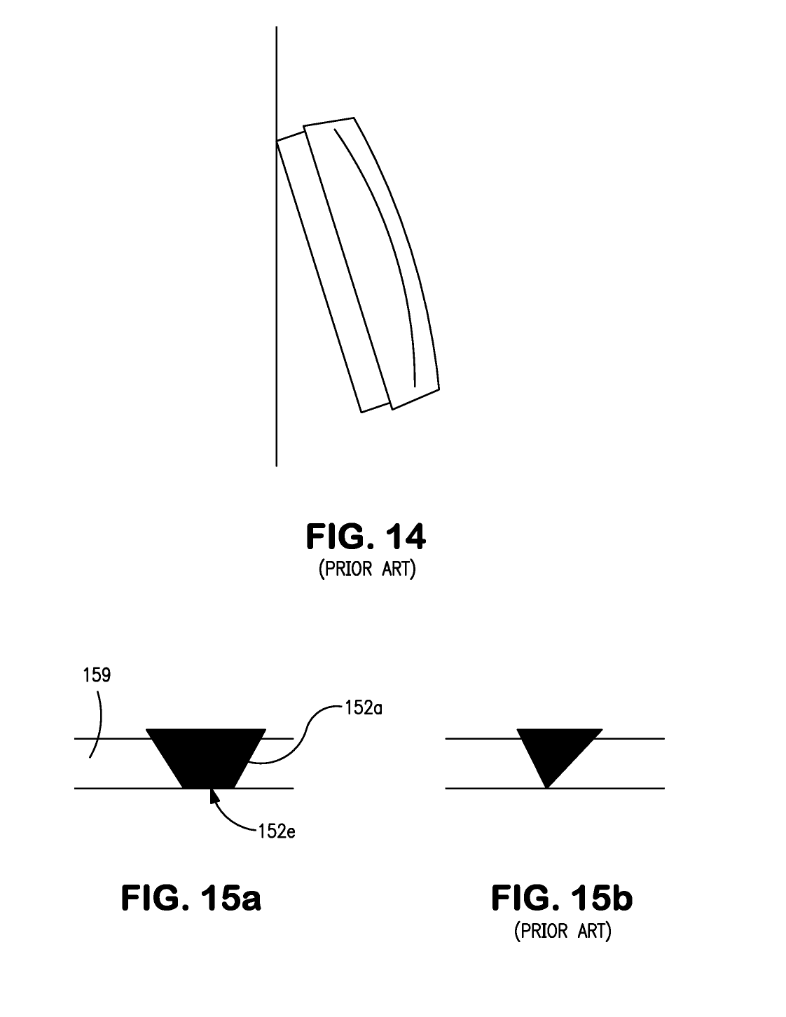

The eraser tool 152 is best illustrated in FIG. 12. As can be seen, eraser tool 152 has an eraser pad 152a attached to a handle 152b that is sized to be gripped by a user. In this embodiment, eraser pad 152a has a main erasing surface 152c and two faceted end erasing surfaces 152d. The inclusion of both a main erasing surface 152c and faceted end erasing surfaces 152d allows eraser tool 152 to be used for erasing areas of different sizes in a facile manner, as illustrated FIGS. 13a and 13b. Additionally, faceted end erasing surfaces 152d provide narrow surfaces for detailed erasing of smaller areas, but which are wide enough to prevent the eraser tool 152 from being inadvertently recognized as a pointer tool during processing of image frames acquired by the imaging assemblies 60, as shown in FIG. 15a. As will be appreciated, this provides an advantage over prior art eraser tools such as that illustrated in FIG. 14, which are sometimes difficult to discern from a pointer tip during processing of image frames acquired by the imaging assemblies, as shown in FIG. 15b.

The positioning of the master controller 50 and the associated electronics in the interior of tool tray 48 provides the advantage of easy user accessibility for the attachment of accessory modules to the interactive input system 20. Such accessory modules can include, for example, a module for wireless communication with one or more external devices. These external devices may include, for example, a user's personal computing device configured for wireless communication, such as a portable laptop or tablet, a smartphone or personal digital assistant (PDA), one or more wireless student response units, or any other device capable of wireless communication. Such accessory modules can alternatively include, for example, a communication module for non-wireless (i.e. “wired”) communication with one or more external devices, or with a peripheral input device. As will be appreciated, the need to interface with such devices may vary throughout the lifetime of the interactive input system 20. By conveniently providing removable accessory modules for the tool tray 48, the user is able to modify or update the functionality of the tool tray in a facile manner and without having instead to replace the entire tool tray or the entire interactive board 22. Additionally, if, in the unlikely event, a component within one of the accessory modules were to fail, replacement of the defective component by the end user would be readily possible without the need for assistance of a professional installer and/or without returning the interactive board 22 to the manufacturer. Also, as frame assemblies typically comprise metal, the positioning of a wireless communication interface in the tool tray 48 reduces any interference that may otherwise occur when connecting such an interface behind the interactive board, as in prior configurations. Additionally, the positioning of the attachment points for accessory modules at the ends of the tool tray 48 permits accessory modules of large size to be accommodated, as needed.

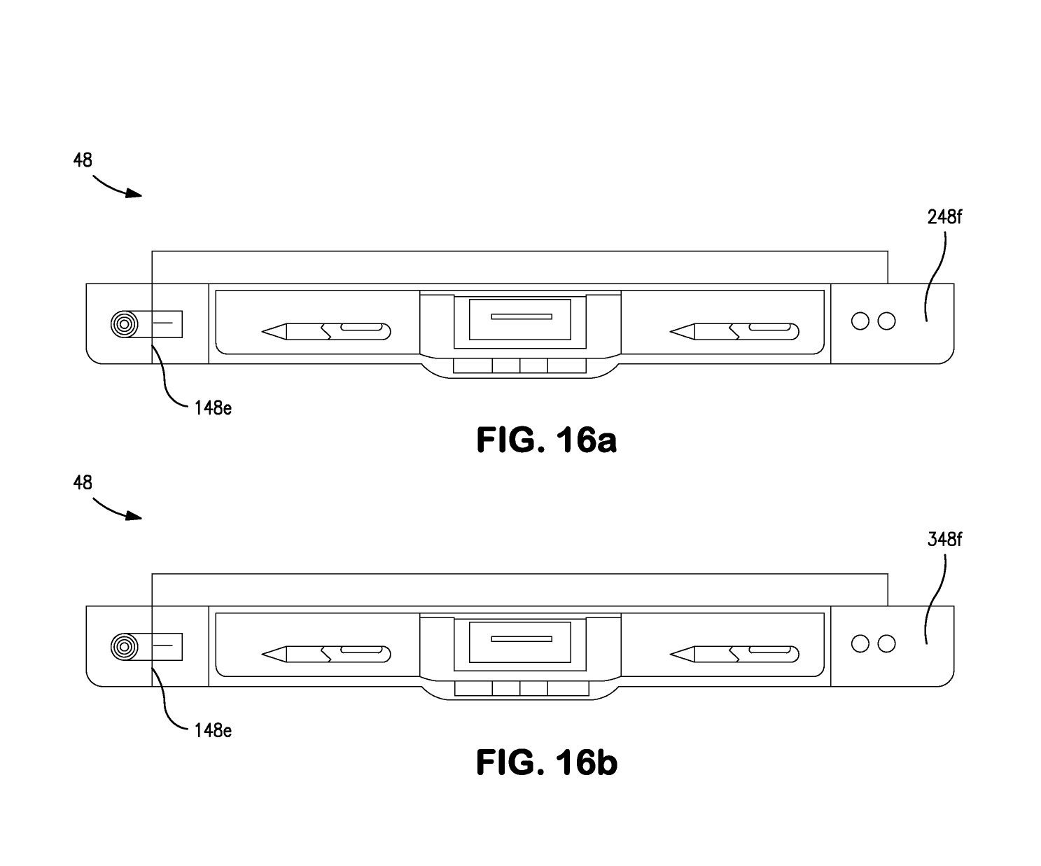

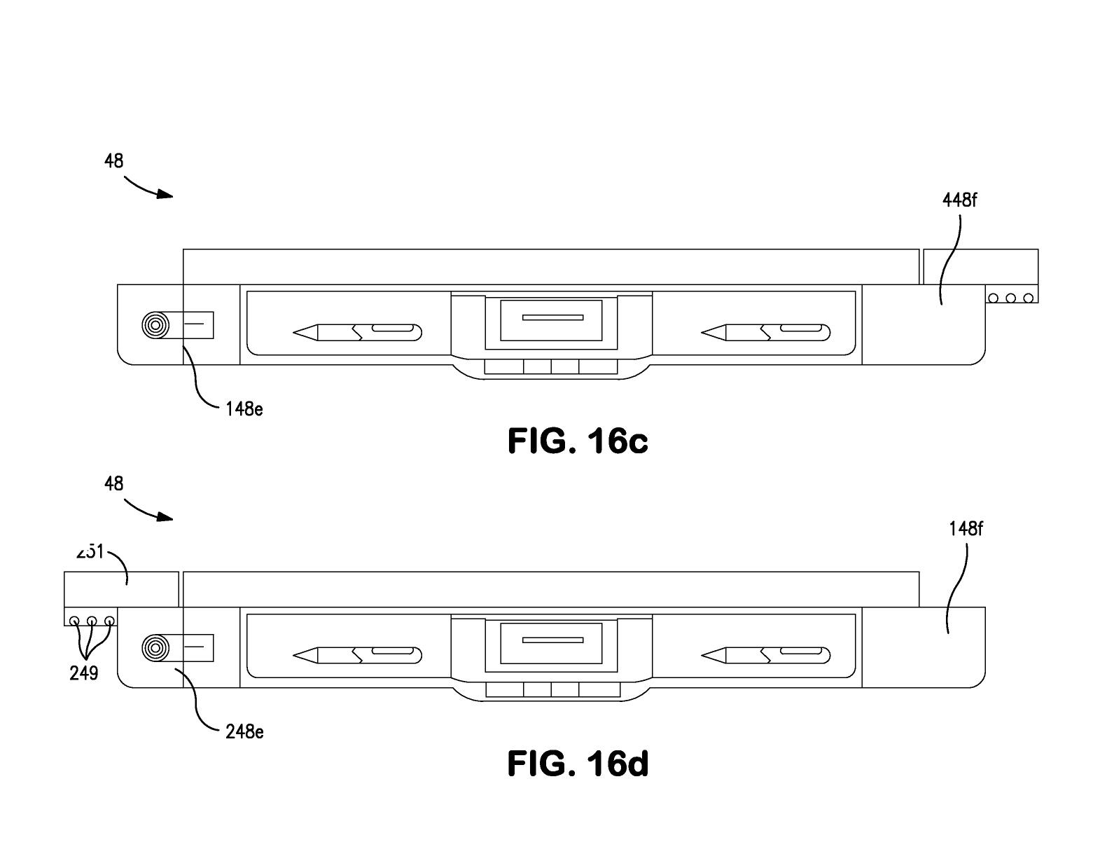

The removable accessory modules permit a wide range of functions to be added to the tool tray 48. For example, FIGS. 16a to 16c show a variety of communications modules for use with tool tray 48, and which may be used to enable one or more external computers or computing devices (e.g. smartphones, tablets, laptops, PDAs storage devices, cameras, etc.) to be connected to the interactive input system 20. FIG. 16a shows a wireless communications module 248f connected to the housing 48a of tool tray 48. Wireless communications module 248f allows one or more external computers such as, for example, a user's personal computer, to be connected to the interactive input system 20 for the purpose of file sharing or screen sharing, for example, or to allow student response units to be connected to the interactive input system 20 while the general purpose computing device 28 runs student assessment software, for example. FIG. 16b shows an RS-232 connection module 348f connected to the housing 48a of the tool tray 48 for enabling a wired connection between the tool tray 48 and an external computer or computing device. FIG. 16c shows a USB communication module 448f having a plurality of USB ports connected to the housing 48a of the tool tray 48, for enabling a wired USB connection between the tool tray 48 and one or more external computers, peripheral devices, USB storage devices, and the like.

The accessory modules are not limited to extending communications capabilities of the tool tray 48. For example, FIG. 16d shows a projector adapter module 248e connected to the housing 48a of tool tray 48. Projector adapter module 248e enables tool tray 48 to be connected to an image projector, and thereby provides an interface for allowing the user to remotely control the on/off status of the projector. Projector adapter module 248e also includes visual indicators 249 and a text display 251 for indicating status events such as projector start-up, projector shut-down, projector bulb replacement required, and the like. Still other kinds of accessory modules are possible for use with tool tray 48, such as, for example, extension modules comprising additional tool receptacles, or extension modules enabling the connection of other peripheral input devices, such as cameras, printers, or other interactive tools such as rulers, compasses, painting tools, music tools, and the like.

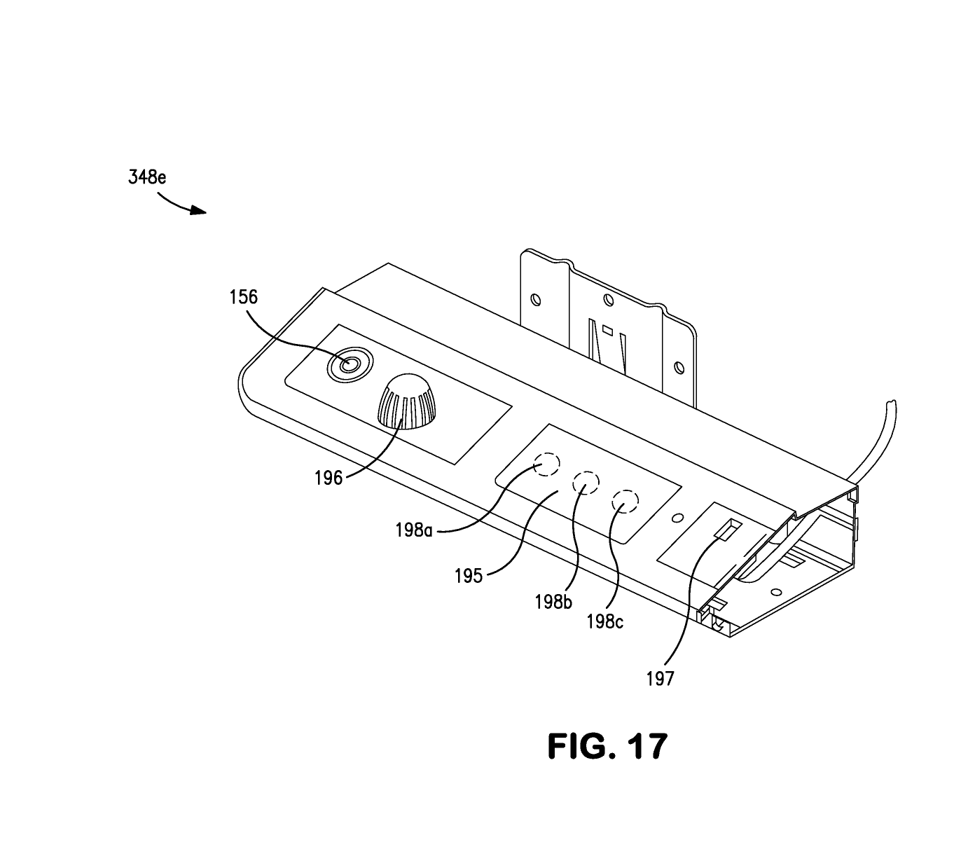

FIG. 17 shows another tool tray accessory module for use with the tool tray 48, generally indicated by reference numeral 348e. Accessory module 348e comprises a colour LCD touch screen 195, a volume control dial 196, together with a power button 156, and a USB port 197. Touch screen 195 provides a customizable interface that is configurable by the user for meeting a particular interactive input system requirement. The interface may be configured by the user as desired, for example depending on the type of other accessories connected to the tool tray 48, such as a wireless communications accessory. In the embodiment shown, touch screen 195 displays three user selectable buttons, namely a button 198a to enable switching between video inputs, a button 198b for bringing up controls for projector settings, and a help button 198c for providing general assistance to the user for interactive input system operation.

Pressing the video switching control button 198a results in the list of available video inputs to the projector being to be displayed on touch screen 195. For example, these may be identified simply as VGA, HDML composite video, component video, and so forth, depending on the type of video input. If the projector has more than one particular type of video input, these could be enumerated as VGA1, VGA2, for example. Alternatively, the touch screen 195 could display a list of particular types of devices likely to be connected to those video ports. For example, one input could be referred to as “Meeting Room PC”, while another could be referred to as “Guest Laptop”, etc. Selecting a particular video input from the list of available video inputs displayed causes a video switching accessory (not shown) installed in the tool tray 48 to change to that video input. The video switching accessory in this case comprises input ports (not shown) corresponding to various formats of video input, such as VGA, composite video, component video, and the like, for allowing the connection of laptops, DVD players, VCRs, Bluray players, gaming machines such as Sony Playstation 3, Microsoft Xbox 360 or Nintendo Wii, and/or other various types of video/media devices to the interactive input system.

In an alternative embodiment, the accessory modules may provide video input ports/USB ports to allow a guest to connect a laptop or other processing device to the interactive board 22. Further, connecting the guest laptop may automatically launch software from the accessory on the laptop to allow for complete functionality of the board. In an alternative embodiment, the accessory modules may be configured to enable one or more other modules to be connected to it in series. In this case, the modules may communicate in a serial or parallel manner with the master controller 50.

During use, when a pen tool P is removed from its receptacle 48c and its removal is detected by the sensors 172 therein, the interactive board 22 is conditioned to an ink mode so that when the pen tool P is brought into contact with the interactive surface 24 and moved thereover, digital ink corresponding to the pen tool P movement is injected into the application executing on the general purpose computing device 28 and displayed on the interactive surface 24. A check however is made to determine if one of the attribute buttons 154a, 154b or 155a to 155d has been selected and thus, to determine if an attribute has been assigned to the pen tool P. If no attribute button has been selected, a default attribute is assigned to the pen tool, in this example a black colour, resulting in black digital ink being injected into the executing application program when the pen tool P is brought into contact with the interactive surface 24.

If an attribute button has been selected, for example, if the user selects attribute button 155d, which is associated with the colour red, when the pen tool P is brought into contact with the interactive surface 24 and moved thereover, red digital ink is injected into the executing application program and displayed on the interactive surface 24. In this case, the LED associated with the attribute button 155d blinks or remains in an illuminated state to provide a visual indication of the attribute assigned to the pen tool input. Depressing the same attribute button again results in the assigned attribute becoming inactive, the LED associated with the attribute button being turned off and the attribute assigned to pen tool P reverting to the default value (the black colour, for example). As will be appreciated, the provision of the attribute buttons enables an attribute of pointer input to be selected by a user in a more intuitive and easy-to-use manner than prior interactive input systems. Alternatively, the pointer attribute may be selectable from a software toolbar or menu as presented on the interactive surface 24, whereby a button (not shown) on the tool tray 48 could be used to direct the general purpose computing device 28 to display such a toolbar or menu.

When the eraser tool 152 is removed from its receptacle 150 and its removal is detected by the sensors 172 therein, the interactive board 22 is conditioned to an erase mode so that when the eraser tool 152 is brought into contact with the interactive surface 24 and moved thereover, displayed digital ink over which the eraser tool is moved is erased. A check however is made to determine if one of the attribute buttons 154a, 154b or 155a to 155d has been selected and thus, to determine if an attribute has been assigned to the eraser tool 152. If no attribute button has been selected, a default attribute is assigned to the eraser tool, which in this example results in all digital ink over which the eraser tool 152 is moved being erased. If an attribute button has been selected, for example, if the user again selects attribute button 155d, which is associated with the red colour, when the eraser tool 152 is brought into contact with the interactive surface 24 and moved thereover and over displayed digital ink, a check is performed to determine if the eraser tool has passed over digital ink having an attribute matching the attribute assigned to the eraser tool (i.e. red digital ink). If the digital ink does not have an attribute matching the attribute assigned to the eraser tool, the digital ink is not erased. If the digital ink has an attribute matching the attribute assigned to the eraser tool, the digital ink is erased.

Although the example above describes attribute buttons 155a to 155d being associated with particular colours, those of skill in the art will appreciate that different attributes may be associated with the attribute buttons 155a to 155b. For example, the attribute buttons may be associated with colours different than those described above. Alternatively, the attribute buttons may be associated with different digital ink line thicknesses or widths, different digital ink fonts, different digital ink line types, different digital ink line shapes, different digital ink line orientations, different graphical object sizes and/or shapes, different locations on the interactive surface 24, different ages of digital ink (defined as the length of time that has passed since the digital ink was written or created on the interactive surface 24) or combinations thereof.

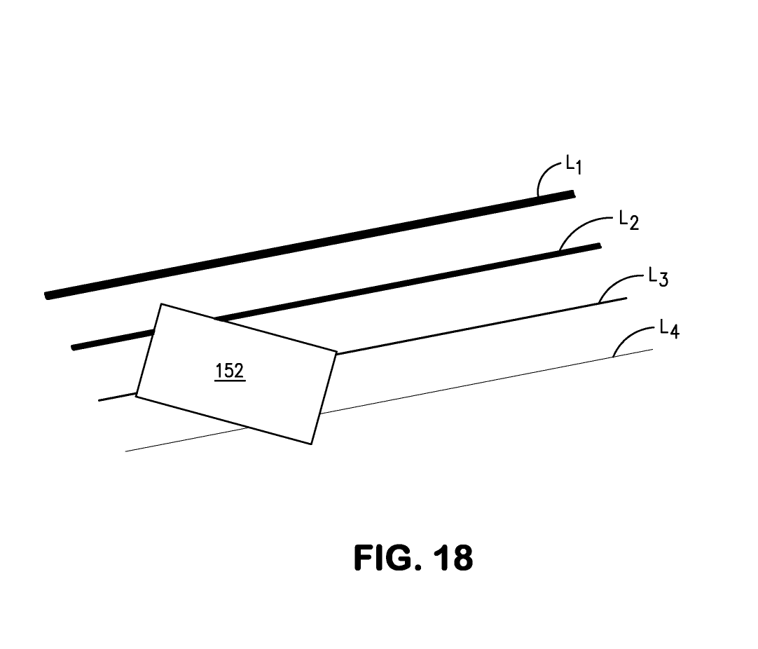

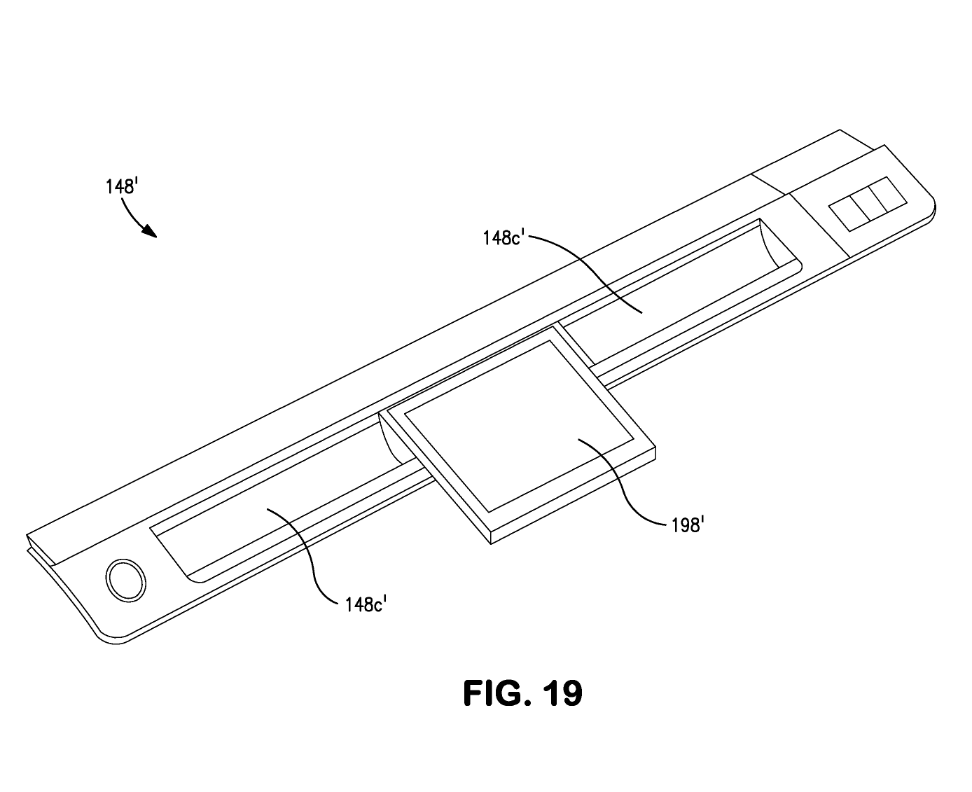

For ease of illustration, FIG. 18 shows four lines L₁ to L₄ of digital ink displayed on interactive surface 24 with each digital ink line having a different thickness. An eraser tool 152 that has been assigned a particular line thickness attribute as a result of selection of an attribute button associated with that line thickness has passed over the four lines of digital ink. A portion of the line L₃ having the attribute matching the attribute assigned to the eraser tool is erased, while the three lines L₁, L₂ and L₄ of the digital ink, that do not have an attribute matching the attribute assigned to the eraser tool 152 remain displayed. As will be appreciated, the opposite case could be implemented wherein digital ink having an attribute matching the attribute assigned to the eraser tool 152 is not erased and all digital ink that does not have an attribute matching the attribute assigned the eraser tool is erased.

Tool tray 48 also provides functionality for cases when multiple users interact with the interactive surface 24. In this case, when multiple pen tools P are detected to be absent from their receptacles 48c, the interactive input system 20 presumes there are multiple users present and conditions the interactive board 22 to a split-screen mode. Such a split-screen mode is described in U.S. Patent Application Publication No. 2011/0043480 to Popovich et al., entitled “MULTIPLE INPUT ANALOG RESISTIVE TOUCH PANEL AND METHOD OF MAKING SAME”, filed on Jun. 25, 2010, and assigned to SMART Technologies ULC, the entire disclosure of which is incorporated herein by reference. The attribute to be assigned to each pen tool and any other pointers may be selected using the attribute buttons 154a to 155d as described above. In this case, the attribute associated with the selected attribute button is applied to all pointers on both split-screens. Alternatively, each split-screen may display a respective software toolbar or menu for attribute selection allowing selected pointer attributes to be applied to all pointer activity within the respective side of the split-screen. In this case, pointer attributes selected via the displayed toolbars or menus may be used to override any attribute selection made using attribute buttons 154a to 155d. If a common attribute is selected using the software toolbar or menu on both split-screens that is associated with the attribute assigned to one of the attribute buttons 154a to 155d, the indicator LED associated with that attribute button is activated.

When a pen tool P and an eraser tool 152 are detected to be absent from their receptacles 48c and 150, rather than conditioning the interactive board 22 to a split-screen mode, the interactive input system 20 assigns an attribute to the eraser tool 152 that matches the attribute assigned to the pen tool P so that digital ink resulting from contact between the pen tool P and the interactive surface 24 can be readily erased using the eraser tool 152.

The pointer attribute selection capabilities provided by tool tray 48 are not limited to input by pen and eraser tools associated with receptacles 48c and 150, and may be applied to other pointers (e.g. a finger) used with the interactive input system 20. Additionally, a pointer attribute selected using any of attribute buttons 154a to 155d may be applied to input from any pointer (e.g. a finger, a tennis ball) while the tools are present within the receptacles. Such a mode can be useful for users with special needs, for example. This mode of operation may be enabled by depressing an attribute button 154a to 155d and then bringing a pointer into proximity with interactive surface 24, and may be reset upon removal of a pen tool or eraser tool from its receptacle 48c, 150.

Turning now to FIG. 19, an alternative tool tray 148′ similar to that shown in above-incorporated U.S. patent application Ser. No. 13/027,717 is shown. In this embodiment, rather than including attribute buttons, the tool tray 148′ comprises a display 198′ that is centrally positioned on the upper surface of the tool tray housing 148a′. In this example, the display 198′ is a colour liquid crystal display (LCD) panel having a resistive touch layer thereon. The resistive touch layer enables the display 198′ to receive touch input and thereby allows a user to interact with the display using a pen tool, finger or other suitable object. Those of skill in the art will however appreciate that other types of displays and touch sensing technology (e.g. electromagnetic, capacitive, acoustic, machine vision etc.) may be employed. The upper surface 148b′ of the tool tray 148′ is configured to define a pair of receptacles or slots 148c′, with each receptacle or slot being positioned on an opposite side of the display 198′. The receptacles 148c′ are configured to receive a pen tool P and an eraser tool 152.

Display 198′ is connected to the power adaptor 62 through the main controller board 160 housed within the tool tray 148′ thereby to allow a user to switch power on and off to selected components of the interactive input system 20, such as for example, the projector, through touch interaction with the display 198′. A microcontroller (not shown) having an embedded Linux operating system for controlling the operation of the display 198′ is mounted on the main controller board 160. The microcontroller is also in communication with the master controller 50, enabling touch input made on the display 198′ to be reflected in images displayed on the interactive surface 24, and also enabling touch input made on the interactive surface 24 to be reflected in images presented on the display 198′. As will be understood, since the interactive surface 24 and display 198′ are each connected to and controlled by separate controllers, input events on the display 198′ will not shift focus away from or interrupt programs running on the general purpose computing device 28 and displayed on the interactive surface 24. In this manner, display 198′ is not merely an extension of any “desktop environment” displayed on the interactive surface 24, but rather functions as a separate “environment” simultaneously with any “environment” displayed on the interactive surface 24.

The main controller board 160 is also in communication with the attribute controller board 170. As a result, display 198′ is configured to display a pointer attribute selection screen whenever a pen tool P or eraser tool 152 is removed from its receptacle 148c′ as detected by the sensors 172 associated with the receptacle. Thus, as will be appreciated, the pointer attribute selection screen presented on the display 198′ can be used to assign an attribute, such as those discussed above, to a pen tool P or eraser tool 152 removed from its receptacle.

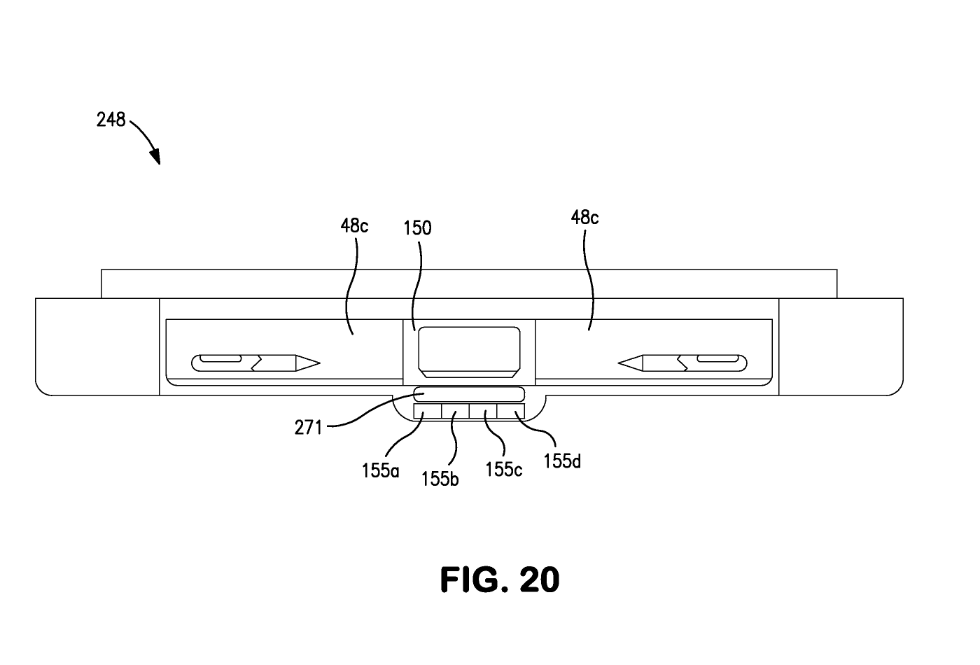

FIG. 20 shows another embodiment of a tool tray for use with the interactive input system 20, and generally indicated by reference numeral 248. Tool tray 248 is generally similar to the tool tray 48 described above with reference to FIGS. 6 to 11, except that it has a single indicator 271 for indicating the attribute status as selected using attribute buttons 155a to 155d, as opposed to individual LEDs associated with each of the attribute buttons 155a to 155d. Indicator 271 in this example comprises one or more multicolour LEDs, however those of skill in the art will appreciate that the indicator is not limited to this configuration. For example, indicator 271 may instead comprise a plurality of differently coloured LEDs sharing a common lens. The use of indicator 271 having a multicolour capability allows for a combination of standard colours (namely black, blue, red and green) to be displayed. Alternatively, the indicator 271 could be in the form of a colour LCD screen to display the selected attribute.

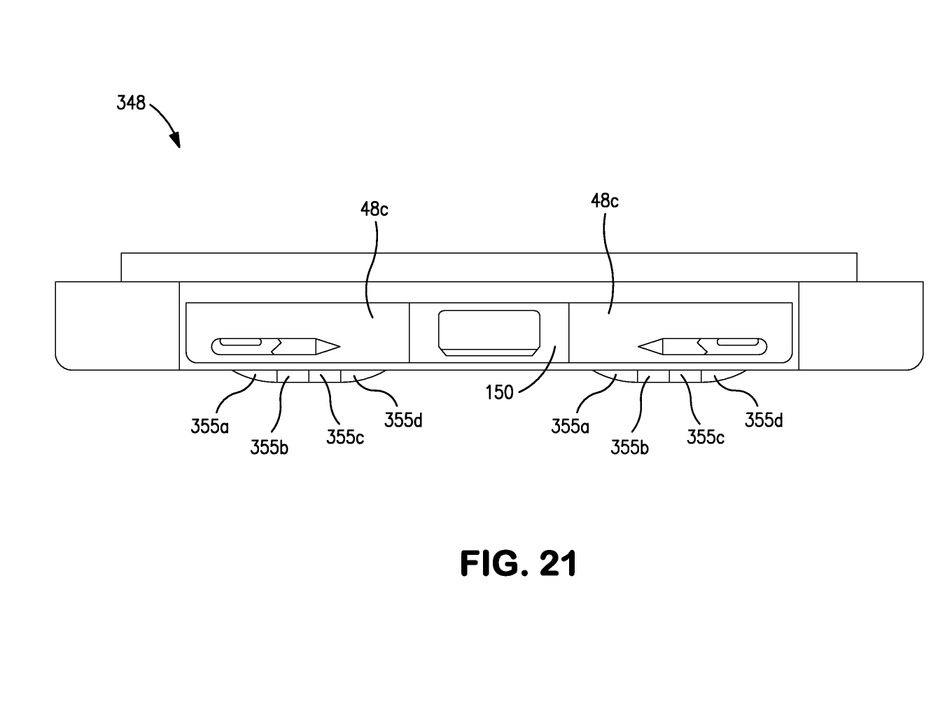

FIG. 21 shows still another embodiment of a tool tray for use with the interactive input system 20, and generally indicated by reference numeral 348. Tool tray 348 is again similar to the tool tray 48 described above with reference to FIGS. 6 to 11, except that it has two sets of attribute buttons as opposed to a single set of attribute buttons. In this example, one set comprises attribute buttons 355a to 355d and the other set comprises attribute buttons 355e to 355h. Each set of attribute buttons is associated with a respective receptacle 48c. In the split screen mode, the attribute assigned to pointer input associated with each split screen may be selected by depressing one of the attribute buttons 355 associated with that screen.

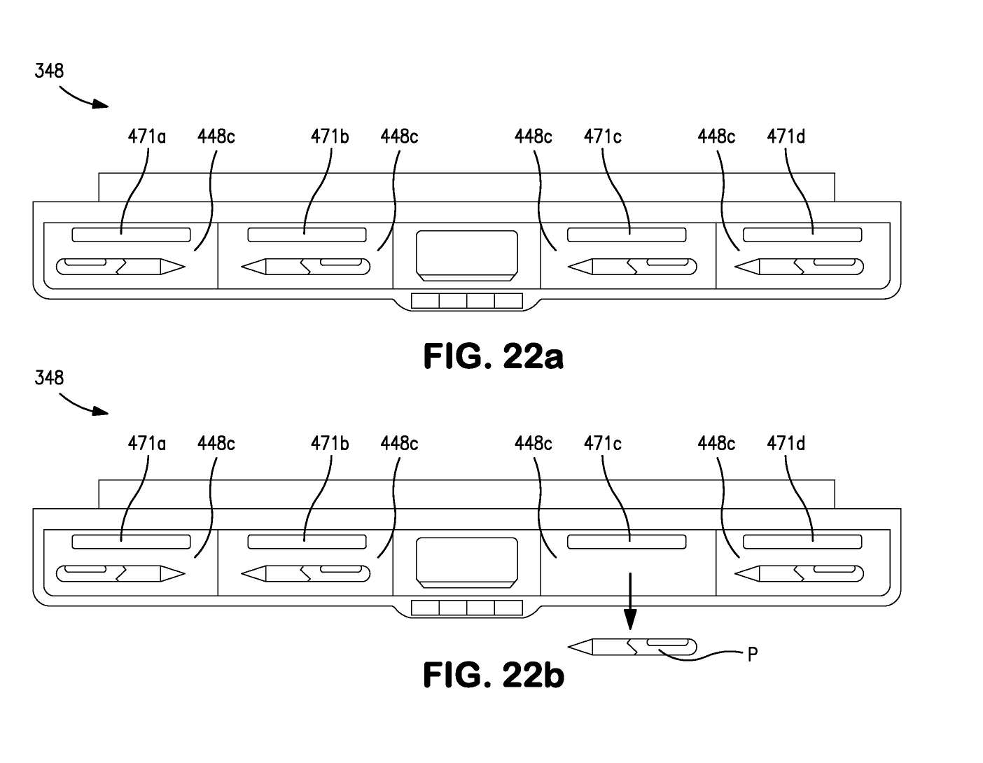

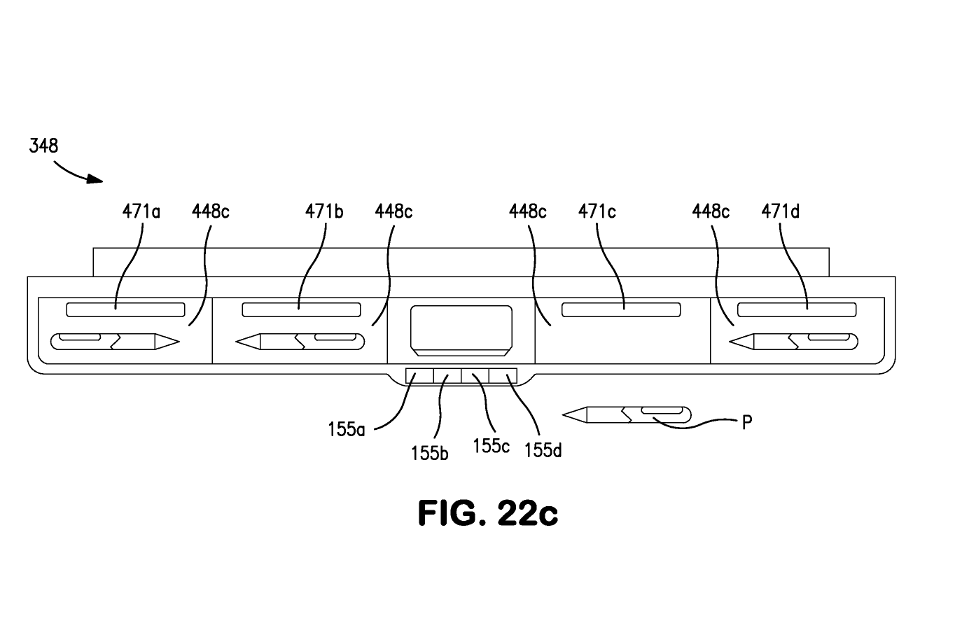

FIGS. 22 to 22c show still another embodiment of a tool tray for use with the interactive input system 20, and which is generally indicated by reference numeral 448. Tool tray 448 is generally similar to tool tray 48 described above with reference to FIGS. 6 to 11, except that it has four receptacles 448c each supporting a respective pen tool. Additionally, each receptacle 448c has a single multicolour LED indicator 471a to 471d associated with it for indicating status of the attribute assigned to the pen tool in that respective receptacle 448c. In the embodiment shown, the tool tray is configured such that the indicators display the colour status of each pen tool when all pen tools are in their respective receptacles 448c (FIG. 22a). When a pen tool is removed from its receptacle 448c (FIG. 22b), all of the tools are assigned the colour associated with the removed pen tool. In this configuration, depressing an attribute button assigns the attribute, in this example colour, associated with that attribute button to all of the pen tools (FIG. 22c), which may be used to override any colour previously assigned to all of the pen tools, such as that in FIG. 22b.

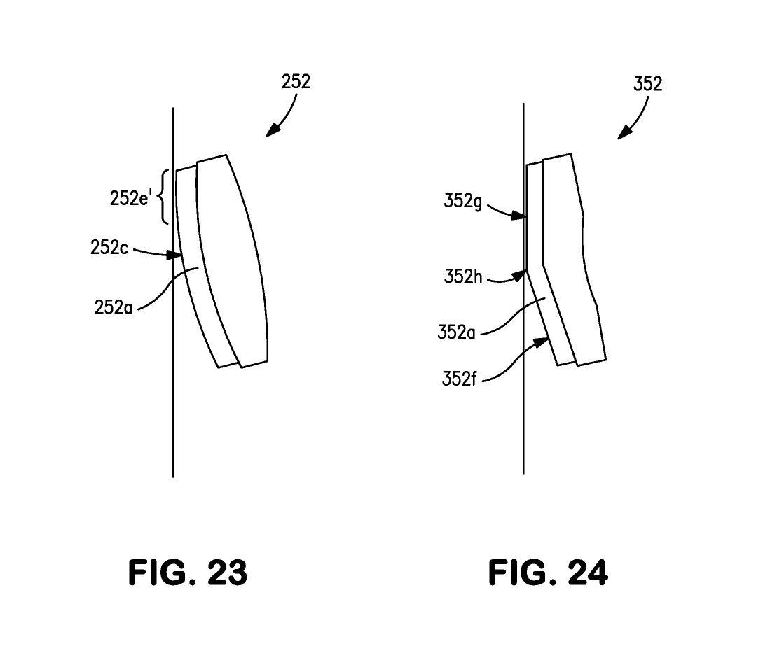

Although in embodiments described above, the eraser tool is described as having an eraser pad comprising a main erasing surface and faceted end erasing surfaces, other configurations are possible. For example, FIG. 23 shows another embodiment of an eraser tool, generally indicated by reference number 252, having an eraser pad 252a with a generally rounded shape. This rounded shape of eraser pad 252a allows a portion 252e of erasing surface 252c to be used for erasing. As will be appreciated, portion 252e is narrow enough to allow eraser tool 252 to be used for detailed erasing, but is wide enough to allow eraser tool 252 to be discernable from a pointer tip, during processing of image frames acquired by the imaging assemblies 60.

FIG. 24 shows yet another embodiment of an eraser tool, generally indicated by reference number 352, having an eraser pad 352a with a generally chevron shape. The chevron shape provides two main erasing surfaces 352f and 352g, which may each be used for erasing. Additionally, main erasing surfaces 352f and 352g are separated by a ridge 352h. As will be appreciated, ridge 352h is narrow enough to allow eraser tool 352 to be used for detailed erasing but is wide enough, owing to the large angle of the chevron shape, to allow eraser tool 352 to be discernable from a pointer tip, during processing of image frames acquired by the imaging assemblies 60.

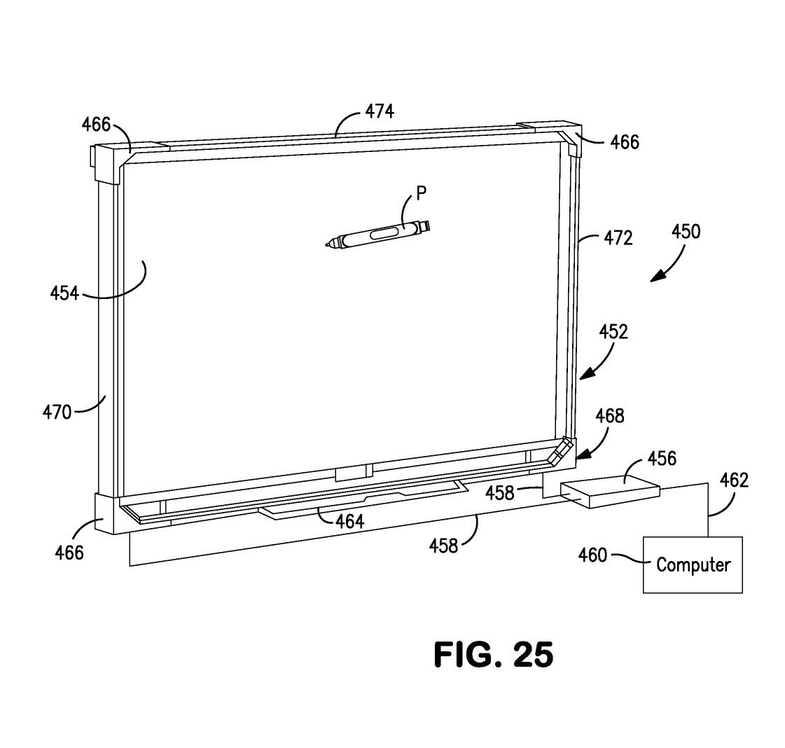

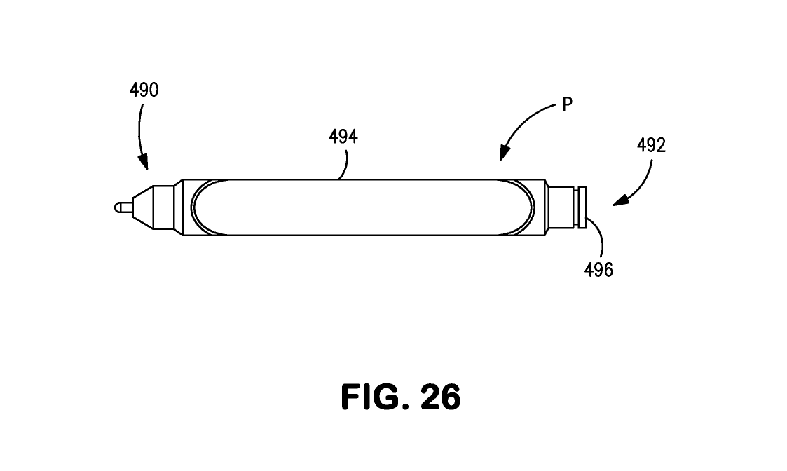

Turning now to FIG. 25, another embodiment of an interactive input system is shown and is generally identified by reference numeral 450. In this embodiment, interactive input system 450 is similar to that disclosed in U.S. Patent Application Publication No. 2009/0277697 to Bolt et al., filed on May 9, 2008 and entitled “INTERACTIVE INPUT SYSTEM AND PEN TOOL THEREFOR”, the entire disclosure of which is incorporated by reference. As can be seen, interactive input system 450 comprises an assembly 452 that engages a display unit (not shown) such as for example, a plasma television, a liquid crystal display (LCD) device, a flat panel display device, a cathode ray tube etc. and surrounds the display surface 454 of the display unit. The assembly 452 employs machine vision to detect pointers brought into a region of interest in proximity with the display surface 454 and communicates with a digital signal processor (DSP) unit 456 via communication lines 458. The communication lines 458 may be embodied in a serial bus, a parallel bus, a universal bus (USB), an Ethernet connection or other suitable wired connection. The DSP unit 456 in turn communicates with a general purpose computing device 460 executing one or more application programs via a USB cable 62. Alternatively, the DSP unit 456 may communicate with the general purpose computing device 460 over another wired connection such as for example a parallel bus, an RS-232 connection, an Ethernet connection etc. or the DPS unit 456 may communicate with the general purpose computing device 460 over a wireless connection using a suitable wireless protocol such as for example Bluetooth, WiFi, ZigBee, ANT, IEEE 802.15.4, Z-Wave etc. A tool tray 464 extends along the bottom edge of the display surface 454 to support one or more active pen tools P such as that shown in FIG. 26. Tool tray 464, similar to the tool trays described previously, allows attributes to be assigned to pen tools. In this embodiment, corner pieces 466 adjacent the bottom left and bottom right corners of the display surface 454 accommodate imaging assemblies 468 that look generally across the entire display surface 454 from different vantages. Bezel segments 470 to 474 are oriented so that their inwardly facing surfaces are seen by the imaging assemblies 468.

In this embodiment, each pen tool P is similar to that described in above-incorporated U.S. Patent Application Publication No. 2009/0277697 and accommodates a tip switch assembly (not shown) at its writing end 490 and a plunger assembly (not shown) at its erasing end 492. When the writing end 490 is brought into contact with the display surface 454 with sufficient force, the tip switch assembly is closed and sensed by a controller (not shown) within the pen tool body 494. The controller conditions a wireless unit (not shown) in the pen tool P that has wireless transmitter positioned proximate the writing end 490 to output a modulated signal that is received by a wireless unit (not shown) connected to the DSP 456.

When the erasing end 492 of pen tool P is brought into contact with the display surface 454 with sufficient force, the end cap 496 of the pen tool P moves causing the plunger assembly to close a switch (not shown). The closing of the switch is sensed by the controller. In response, the controller conditions the wireless unit that also has a transmitter proximate the erasing end 492 to output a differently modulated signal that is broadcast via the wireless transmitter and received by the wireless unit connected to the DSP 456. As will be appreciated, because the pen tool P outputs different modulated signals depending on whether the writing end 490 or erasing end 492 is brought into contact with the display surface 454, the modulated signals can be used to correctly condition the interactive input system 450 to the ink mode when the writing end 490 is brought into contact with the display surface 454 and to the erase mode when the erasing end 492 is brought into contact with the display surface 454.

The wireless signaling employed by the active pen tool P to communicate with the interactive input system 450 can be, for example, radio frequency (RF) or infrared (IR). For example, RF signals can be emitted by the wireless unit of the pen tool when the pen tool P is moved and the movement is detected by an internal accelerometer, when a button on the pen tool P is pushed, or when the pen tool P is brought into contact with the display surface 454. Alternatively, IR signals can be emitted by the wireless unit of the pen tool when the pen tool P is moved and the movement is detected by an internal accelerometer, when a button on the pen tool P is pushed, or when the pen tool P is brought into contact with the display surface 454. In this case, the emitted IR signals can be received by the wireless unit connected to the DSP 456, or alternatively the IR signals can be detected by the imaging assemblies 468.

One skilled in the art will recognize that the signals emitted by the pen tool P may alternatively be sent through a tethered or wired connection that physically couples the pen tool P to the interactive input system 450.

The DSP unit 456 stores a modulated signal-to-pen tool mode mapping table. As a result, when a broadcast modulated signal is received by the wireless unit connected to the DSP 456 and conveyed to the controller of the DSP unit 456, the controller compares the received modulated signal to the mapping table to determine the pen tool mode. The controller of the DSP unit 456 in turn assigns the determined pen tool mode and any assigned pen tool attribute to the generated pointer coordinates and conveys the pen tool mode and attribute along with the pointer coordinates to the general purpose computing device 460 so that the pointer coordinates are processed by the general purpose computing device 460 in the desired manner. As mentioned above, when the writing end 490 of the pen tool P is in contact with the display surface 454, the pen tool P is deemed to be operating in the ink mode. Ink mode information is therefore assigned to pointer coordinates generated by the controller while the pen tool P is in this mode so that the general purpose computing device 460 treats the pointer coordinates as writing or drawing (i.e. digital ink) for presentation on the display surface 454.

When the erasing end 492 of the pen tool P is in contact with the display surface 454, the pen tool P is deemed to be operating in the eraser mode. Erase mode information is therefore assigned to pointer coordinates generated by the controller while the pen tool P is in this mode so that the general purpose computing device 460 erases displayed ink at locations corresponding to the pointer coordinates.

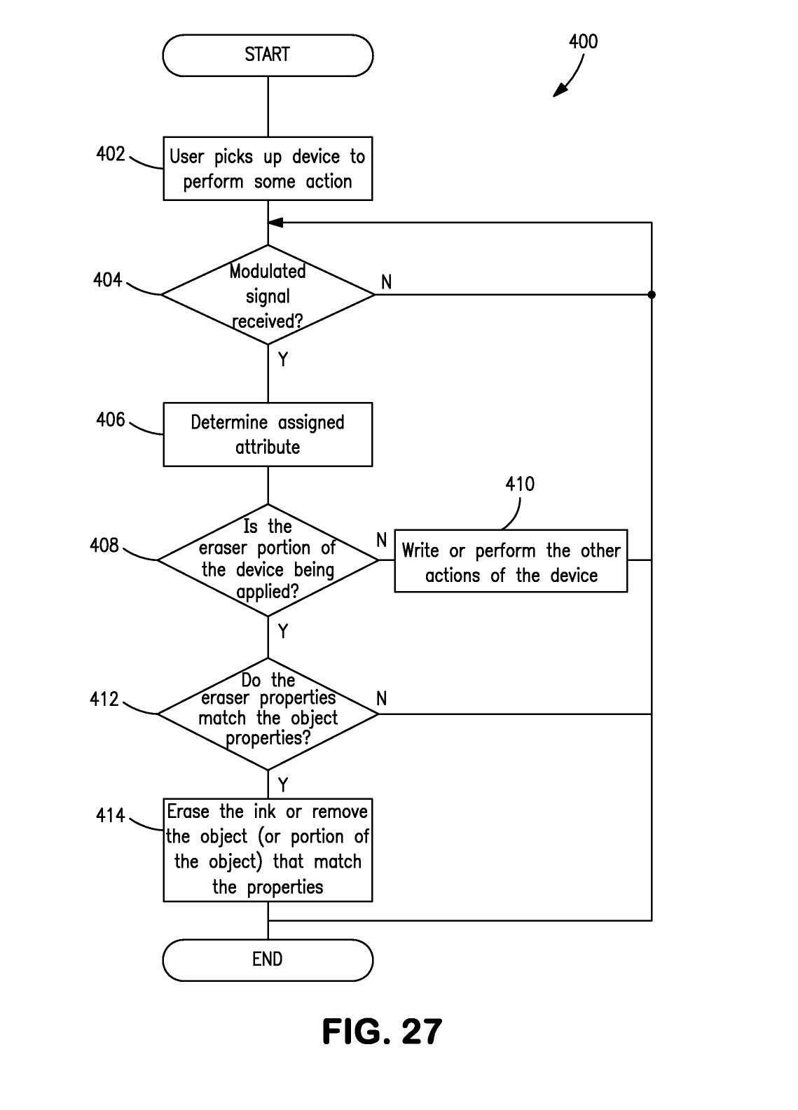

Turning now to FIG. 27, a flowchart showing the steps performed when a pen tool P is removed from the tool tray 464 and used to interact with the display surface 454 is illustrated and generally identified by reference numeral 400. When a user removes a pen tool P from the tool tray 464, the sensors in the tool tray slot, that accommodated the removed pen tool, detect the pen tool removed (step 402). In response, the interactive input system 450 is prompted to await pen tool input and the controller of the DSP 456 is conditioned to check if a modulated signal output by the pen tool P has been received (step 404). If no modulated signal from the pen tool P has been received, the controller simply remains in a ready state awaiting such a modulated signal. At step 404, when the pen tool P is brought into contact with the display surface 454 and the pen tool P emits a modulated signal that is received by the wireless unit connected to the DSP 456, the DSP 456 checks to determine whether a specific attribute has been assigned to the pen tool, such as for example colour, via the tool tray 464 or whether a default attribute has been assigned to the pen tool (step 406). The controller of the DSP 456 then uses the modulated signal-to-pen tool mode mapping table to determine whether the writing end 490 or erasing end 492 of the pen tool P has been used to contact the display surface 454 (step 408). At step 408, if the controller of the DSP 456 determines that the writing end 490 of the pen tool P is used to contact the display surface 454, the pen tool is assumed to be in the ink mode and the controller conveys the pointer coordinates, ink mode information and attribute to the general purpose computing device 460 for processing resulting in digital ink corresponding to the pen tool movement being displayed on display surface 454 (step 410). If however, at step 408 the controller of the DSP 456 determines that the erasing end 492 of the pen tool P is used to contact the display surface 454, the pen tool is assumed to be in the erase mode information and the controller conveys the pointer coordinates, erase mode and attribute to the general purpose computing device 460 for processing. The general purpose computing device 460 in turn determines if the pen tool P has been moved across displayed digital ink and if so, if the attribute assigned to the displayed digital ink matches the attribute assigned to the pen tool P (step 412). If not, the displayed digital ink is unaltered. If so, the digital ink in the path of the pen tool P is erased (step 414).

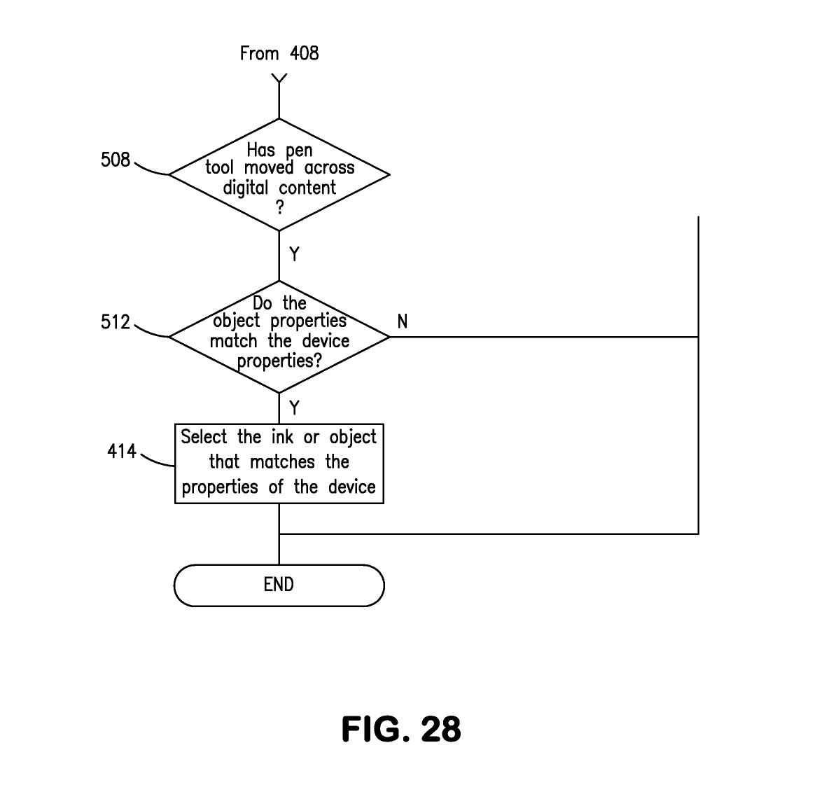

Those of skill in the art will appreciate that a similar method can be applied to discriminately manipulate digital content as shown in FIG. 28. In this case, at step 410 when the controller of the DSP 456 determines that the writing end 490 of the pen tool P is being used to contact the display surface 454 and the controller conveys the pointer coordinates, ink mode information and attribute to the general purpose computing device 460, the general purpose computing device performs a check to determine if the writing end 490 has been moved across any displayed digital content (step 508). If so, a check is made to determine if the digital content has an assigned attribute that matches the attribute assigned to the pen tool P (step 512). If not, the general purpose computing device 460 may either ignore the pen tool input or treat the pen tool input as digital ink. If however, the digital content has an assigned attribute that matches the attribute assigned to the pen tool P, the digital content is selected and subjected to an action (step 514). For example, the selection could be followed by one of a number of actions including but not limited to cutting, pasting, moving, rotating, highlighting, converting handwriting to text, bolding, changing font type, size or colour or reading text audibly.

If desired, the tool tray may be used to assign a different attribute to the writing end and erasing end of each pen tool. Alternatively, the pen tool itself may have a switch or other mechanism to allow attributes to be assigned to the writing and erasing ends of the pen tool. In this case, attribute information is included in the modulated signals emitted by the pen tool. Also, each pen tool P may have a number of attributes available that are selectable by a user. For example, as the pen tool P is tilted, the attributes could change. Shaking the pen tool P could scroll through the available attributes. Moving the pen tool P near another device or a selection pan could result in the attribute assigned to the pen tool P changing based on the attribute associated to the other device or selection pan. For example, moving pen tool P near a device that has a blue attribute would select a blue attribute for pen tool P. Alternatively, the pen tool P could be positioned proximate to a particular colour on a displayed paint pallet to assign a colour attribute to the pen tool P. The pen tool P could alternatively comprise a button, slider or selection wheel for scrolling through the available attributes.

As will be appreciated, pen tool P may have more than one assigned attribute. For example, pen tool P may have a colour attribute of red, and a shape attribute of circle. In this embodiment, pen tool P could be used to selectively erase all digital ink that is red, all digital ink that is a circle, or all digital ink that is a red circle. Of course, the alternative could be applied where pen tool P could be used to erase all digital ink that is not red, all digital ink that is not a circle, or all digital ink that is not a red circle.

Where pen tool P may have more than one assigned attribute, each attribute could be determined or selected by one or more methods. For example, pen tool P could have a colour attribute of blue and a shape attribute of a star. The pen tool P could send out an RF signal when it is brought into contact with the display surface, indicating that it is blue. Once pen tool P is brought into contact with the display surface, the interactive input system could determine that the pen tool P is a star shape. Pen tool P could be used to selectively erase all digital ink that is blue, all digital ink that is a star, or all digital ink that is a blue star. Of course, the alternative could be applied where pen tool P could be used to erase all digital ink that is not blue, all digital ink that is not a star, or all digital ink that is not a blue star.

Although in embodiments described above, the tool tray comprises buttons for inputting information, in other embodiments, the tool tray may comprise other features such as dials for inputting information. In still other embodiments, each receptacle may be associated with a particular attribute, and when it is determined that a tool has been removed from the receptacle it is assumed that the particular attribute has been selected.

Although in embodiments described above, the tool tray housing comprises attribute buttons, in other embodiments, the attribute buttons may instead be positioned on an accessory module.

Although in embodiments described above, the tool tray comprises one or more receptacles for supporting tools, in an alternative embodiment, an accessory module may comprise one or more receptacles. In this case, the accessory module can enable the interactive input system to operate with multipointer functionality and in a split screen mode.

Although in embodiments described above, the tool tray is located generally centrally along the bottom edge of the interactive board 22, in other embodiments, the tool tray may alternatively be located in another location relative to the interactive board, such as towards a side edge of the interactive board 22.

Although in embodiments described above, the interactive input system uses imaging assemblies for the detection of one or more pointers in proximity with a region of interest, in other embodiments, the interactive input may instead use another form of pointer detection. In such embodiment, the interactive input system may comprise for example an analog resistive touch surface, a capacitive-based touch surface etc.

In embodiments described above, a short-throw projector is used to project an image onto the interactive surface 24. As will be appreciated other front projection devices or alternatively a rear projection device may be used to project the image onto the interactive surface 24. Rather than being supported on a wall surface, the interactive board 22 may be supported on an upstanding frame or other suitable support. The interactive board may also be in the form of a touch table and thus assume a generally horizontal orientation. Still alternatively, the interactive board 22 may engage a display device such as for example, a plasma television, a liquid crystal display (LCD) device etc. that presents an image visible through the interactive surface 24. The attribute assigning and processing methodologies described above may also be employed in an interactive projector that projects an image on a wall or other suitable surface and detects pointer interaction with the displayed image.

Although a specific processing configuration has been described, those of skill in the art will appreciate that alternative processing configurations may be employed. For example, one of the imaging assemblies may take on the master controller role. Alternatively, the general purpose computing device may take on the master controller role.

Although embodiments have been described, those of skill in the art will appreciate that variations and modifications may be made with departing from the scope thereof as defined by the appended claims

What is claimed is:

1. A method comprising:
detecting when an input device is moved across digital content presented on a display surface and comparing at least one attribute assigned to the input device with at least one attribute assigned to the digital content; and
based on the result of the comparison, manipulating the digital content.

2. The method of claim 1 further comprising assigning the at least one attribute to the input device in response to user interaction.

3. The method of claim 2 wherein the at least one attribute is assigned to the input device in response to user interaction with a tool tray that is configured to hold said input device.

4. The method of claim 3 wherein said input device is an erasing tool and wherein said manipulating comprises erasing digital content.

5. The method of claim 4 wherein said digital content comprises digital ink.

6. The method of claim 5 wherein said erasing comprises erasing digital ink that has an assigned at least one attribute that matches the at least one attribute assigned to said digital ink.

7. The method of claim 6 wherein the at least one attribute assigned to said erasing tool is selected from digital ink color, digital ink shape, digital ink line width, digital ink line type, digital ink format, digital ink location on the display surface and age of the digital ink.

8. The method of claim 5 wherein said erasing comprises erasing digital ink that has an assigned at least one attribute that does not match the at least one attribute assigned to said digital ink.

9. The method of claim 8 wherein the at least one attribute assigned to said erasing tool is selected from digital ink color, digital ink shape, digital ink line width, digital ink line type, digital ink format, digital ink location on the display surface and age of the digital ink.

10. The method of claim 2 wherein the at least one attribute is assigned to the input device in response to user interaction with a graphical user interface presented on said display surface.

11. The method of claim 10 wherein said input device is an erasing tool and wherein said manipulating comprises erasing digital content.

12. The method of claim 11 wherein said digital content comprises digital ink.

13. The method of claim 12 wherein said erasing comprises erasing digital ink that has an assigned at least one attribute that matches the at least one attribute assigned to said digital ink.

14. The method of claim 13 wherein the at least one attribute assigned to said erasing tool is selected from digital ink color, digital ink shape, digital ink line width, digital ink line type, digital ink format, digital ink location on the display surface and age of the digital ink.

15. The method of claim 12 wherein said erasing comprises erasing digital ink that has an assigned at least one attribute that does not match the at least one attribute assigned to said digital ink.

16. The method of claim 15 wherein the at least one attribute assigned to said erasing tool is selected from digital ink color, digital ink shape, digital ink line width, digital ink line type, digital ink format, digital ink location on the display surface and age of the digital ink.

17. The method of claim 1 wherein said input device is a pen tool and wherein said manipulating comprises performing an action involving said digital content.

18. The method of claim 17 wherein said performing is carried out when the pen tool has an assigned at least one attribute that matches the at least one attribute assigned to said digital content.

19. The method of claim 18 wherein said performing is selected from cutting said digital content, copying said digital content, pasting said digital content, moving said digital content, rotating said digital content, highlighting said digital content, converting said digital content to text, reading said digital content audibly, and changing at least one of font size, colour and type of said digital content.

20. The method of claim 17 wherein said performing is carried out when the pen tool has an assigned at least one attribute that does not match the at least one attribute assigned to said digital content.

21. The method of claim 20 wherein said performing is selected from cutting said digital content, copying said digital content, pasting said digital content, moving said digital content, rotating said digital content, highlighting said digital content, converting said digital content to text, reading said digital content audibly, and changing at least one of font size, colour and type of said digital content.

22. The method of claim 1 further comprising, prior to said detecting, determining input device type, said manipulating being based on both the result of the comparing and the input device type.

23. The method of claim 22 further comprising assigning the at least one attribute to the input device in response to user interaction.

24. The method of claim 23 wherein the at least one attribute is assigned to the input device in response to user interaction with a tool tray that is configured to hold said input device.

25. The method of claim 24 wherein said determining comprises examining a signal generated by said tool tray that identifies said input device.

26. The method of claim 25 wherein said signal is generated in response to said input device being removed from said tool tray.

27. The method of claim 26 wherein said input device is an erasing tool and wherein said manipulating comprises erasing digital content.

28. The method of claim 27 wherein said digital content comprises digital ink.

29. The method of claim 28 wherein said erasing comprises erasing digital ink that has an assigned at least one attribute that matches the at least one attribute assigned to said digital ink.

30. The method of claim 29 wherein the at least one attribute assigned to said erasing tool is selected from digital ink color, digital ink shape, digital ink line width, digital ink line type, digital ink format, digital ink location on the display surface and age of the digital ink.

31. The method of claim 28 wherein said erasing comprises erasing digital ink that has an assigned at least one attribute that does not match the at least one attribute assigned to said digital ink.

32. The method of claim 31 wherein the at least one attribute assigned to said erasing tool is selected from digital ink color, digital ink shape, digital ink line width, digital ink line type, digital ink format, digital ink location on the display surface and age of the digital ink.

33. The method of claim 24 wherein said determining comprises examining a signal generated by said input device.

34. The method of claim 34 wherein said input device is a tool comprising a writing end and an erasing end, said signal identifying the end of said tool used to move across said digital content.

35. The method of claim 2 wherein said assigning comprises determining when said input device has been brought into proximity with another device, a selection pan or displayed information having an assigned attribute and assigning the attribute of that proximate device, selection pan or displayed information to the input device.

36. The method of claim 2 wherein the assigned at least one attribute is assigned to all input devices used to move across digital content.

37. The method of claim 2 wherein different attributes are assigned to different input devices used to move across digital content.

38. The method of claim 1 wherein said display surface is divided into different regions and wherein said detecting and manipulating is performed for each region when an input device is moved across digital content displayed thereon.

39. The method of claim 38 wherein the same at least one attribute is assigned to all input devices.

40. The method of claim 38 wherein the at least one attribute assigned to the input devices are not all the same.

41. A non-transitory computer readable medium embodying computer executable instructions, which when executed, carry out the method of:
detecting when an input device is moved across digital content presented on a display surface and comparing at least one attribute assigned to the input device with at least one attribute assigned to the digital content; and
based on the result of the comparison, manipulating the digital content.

42. An apparatus comprising:
memory; and
processing structure communicating with said memory and executing instructions stored therein to cause said apparatus at least to:
detect when an input device is moved across digital content presented on a display surface and compare at least one attribute assigned to the input device with at least one attribute assigned to the digital content; and
based on the result of the comparison, manipulate the digital content.

43. The apparatus of claim 42 further comprising a tool tray accommodating one or more input devices.

44. The apparatus of claim 43 wherein said at least one attribute is assigned to an input device removed from said tool tray in response to user interaction.

45. The apparatus of claim 44 wherein said user interaction is one of user interaction with said tool tray or user interaction with a graphical user interface presented on said display surface.
